(19) United States
(12) Patent Application Publication
(10) Pub. No.: US 2010/0175638 A1
(43) Pub. Date: Jul. 15, 2010

(54) Water Combustion Technology - The Haase Cycle

(76) Inventor: Richard Alan HAASE, Missouri City, TX (US)

Correspondence Address: Richard A Haase, 4402 Ringrose Drive, Missouri City, TX, 77459, US

(21) Appl. No.: 12/086,558

(22) PCT Filed: Dec. 13, 2006
(86) PCT No.: PCT/US2006/048057

§ 371 Date: Jun. 13, 2008

Related U.S. Application Data
(60) Provisional application No. 60/749,727, filed on Dec. 13, 2005.
(60) Provisional application No. 60/782,100, filed on Mar. 14, 2006.

(51) Int. Cl. F02B 43/10; F02B 47/02; F02B 43/00; F01K 23/06; F25J 3/00; F25J 1/02; F02F 1/00; F17C 5/00; F01N 5/02; F16F 15/30; H02K 7/18

(52) U.S. Cl. 123/3; 123/25 C; 123/1 A; 60/670; 62/640; 62/607; 62/643; 123/193.2; 62/54.1; 60/320; 74/572.1; 290/1 A; 290/52

(57) ABSTRACT

The instant invention presents combustion of hydrogen with oxygen producing environmentally friendly combustion products, wherein management of energy and of combustion is improved. The instant invention presents improved thermodynamics, thereby improving combustion power and efficiency. The instant invention utilizes steam from combustion to: 1) maintain power output of combustion, 2) provide method(s) of energy transfer, 3) provide method(s) of energy recycle, 4) provide power, and 5) cool the combustion chamber. Steam is used as a potential energy source, both from kinetic and available heat energy, as well as conversion to H₂ and O₂.

### RELATED APPLICATION DATA

This application claims priority on U.S. Provisional Application 60/749,727 filed Dec. 13, 2005 and U.S. Provisional Application 60/782,100 filed Mar. 14, 2006.

### BACKGROUND OF THE INVENTION

1. Field of the Invention

The instant invention relates to improved methods, systems, processes and apparatus for the combustion of hydrogen with oxygen, wherein environmentally friendly combustion products are produced, and wherein the management of energy and of combustion is significantly improved. The instant invention methods, systems, processes and apparatus are herein defined as the Water Combustion Technology (WCT) Instant Invention (WCT Instant Invention). The WCT Instant Invention is based upon the chemistry of Water (H₂O) incorporating Hydrogen (H₂) as the fuel and Oxygen (O₂) as the oxidizer. The WCT Instant Invention does not require a hydrocarbon fuel source. H₂O is the primary product of combustion. This is while in many embodiments the WCT Instant Invention, H₂O is separated into H₂ and O₂, thereby making H₂O an efficient method of storing fuel and oxidizer, e.g. potential energy.

Application of the WCT Instant Invention includes: furnaces, combustion engines, internal combustion engines, turbines, heating or any combustion system wherein mechanical, electrical or heat energy (heat energy can include thrust energy) is created. The WCT Instant Invention contains embodiments wherein Nitrogen (N₂) and Argon (Ar) are partially or totally removed from the fuel mixture to improve the energy output of combustion and/or reduce the pollution output of combustion.

The discovered WCT Instant Invention relates to significantly improved combustion thermodynamics, thereby significantly improving the power and efficiency of combustion. Further, the discovered WCT Instant Invention relates to improved combustion wherein H₂O is added to the combustion chamber, thereby utilizing H₂O during combustion as a heat sink, as well as steam as an energy source. The discovered WCT Instant Invention incorporates embodiments wherein the steam produced by combustion: 1) maintains the power output of combustion, 2) provides method(s) of energy transfer, 3) provides an efficient method of energy recycle, 4) provides power through steam, and 5) cools the combustion chamber. Steam presents a potential (reusable) energy source, both from the available kinetic and the available heat energy, as well as the conversion of the steam into H₂ and O₂.

The discovered WCT Instant Invention relates to generating electricity (electrical energy). Four WCT Instant Invention means of generating electricity are discovered. The first places a steam turbine in the exhaust of a WCT Instant Invention, wherein said steam turbine is driven by steam produced in combustion; wherein said steam turbine turns a generator (the term generator is used herein to define either a generator, an alternator or a dynamo); and wherein at least a portion of said steam energy is converted into said electricity. The second places a generator on the mechanical rotating energy output of a WCT Instant Invention engine, wherein at least a portion of said mechanical rotating energy is converted by the generator into electricity. The third incorporates a physical means of focusing moving air and/or moving H₂O currents onto a turbine, wherein said turbine turns a generator to generate electricity. The fourth uses a photovoltaic cell to generate electrical energy.

It is discovered to use at least a portion of said electricity for the electrolysis of H₂O into H₂ and O₂. It is further discovered and preferred to utilize at least a portion of said H₂ and O₂ in the WCT Instant Invention.

The discovered WCT Instant Invention further relates to separating O₂ from air. Three means are discovered. By the first, O₂ is separated from air by cryogenic distillation, wherein air is chilled and distilled into O₂ and N₂. By the second, air is separated utilizing membranes to produce O₂; said membranes can be of either organic (polymer) construction or of inorganic (ceramic) construction. Further, said membranes can be electrically charged to facilitate an electrolytic separation. By the third, air is separated with Swing Adsorption (SA), wherein said SA can be Pressure Swing Adsorption (PSA) or Vacuum Swing Adsorption (VSA), or both. While the separation of air into O₂ and N₂ can have many degrees of separation efficiency, it is to be understood that the term O₂, as used herein, is to mean at least enriched O₂, wherein the O₂ concentration is at least 40 percent; preferably pure O₂, wherein the O₂ concentration is at least 80 percent; and most preferably very pure O₂, wherein the O₂ concentration is at least 90 percent.

The discovered WCT Instant Invention further relates to metal catalysis, wherein steam produced by the WCT Instant Invention is converted into H₂ and metal oxide(s). It is further discovered and preferred that at least a portion of said H₂ from metal catalysis be used as a fuel in the WCT Instant Invention. As used herein, the term metal catalysis is to mean any metal or combination of metals in the periodic table, wherein the metal or combination of metals will convert the available H₂ within steam or H₂O vapor into the corresponding metal oxide(s) and H₂.

The WCT Instant Invention relates to combustion, wherein the thermodynamics of the Otto Cycle are improved providing improved combustion efficiency and power output, thereby producing the Haase Cycle.

### BACKGROUND OF THE INVENTION

Mankind, has over the centuries, developed many forms of energy, along with many forms of transportation. In the modern economy, energy is needed to literally “fuel” the economy. Energy heats homes, factories and offices; provides electrical power; powers manufacturing facilities, and provides for the transportation of goods and people.

During the 19'th and 20'th centuries mankind developed fossil fuels into reliable and inexpensive energy sources. Today, fossil fuels are used in transportation, manufacturing, electricity generation and heating. This use has caused the combustion products from fossil fuels to be a major source of air and H₂O pollution.

Fossil fuels (hydrocarbons) are used as a fuel along with air as an oxidant to generate combustion energy. Hydrocarbons are either: petroleum distillates such as gasoline, diesel, fuel oil, jet fuel and kerosene; fermentation distillates such as methanol and ethanol; or natural products such as methane, ethane, propane, butane, coal and wood. However, excess hydrocarbon combustion interferes with nature. The products of hydrocarbon combustion were thought to work in concert with nature's O₂-carbon cycle, wherein CO₂ is recycled by plant life photosynthesis back into O₂. However, excess CO₂, e.g. excess combustion, upsets the environment. The combustion of a hydrocarbon can be approximated by:

CₙH₂ₙ₊₂+(3/2n+½)O₂→nCO₂+(n+1)H₂O+Energy

More specifically, for gasoline (2,2,4 trimethyl pentane or n-Octane):

gasoline(n-Octane)+12½O₂→8CO₂+9H₂O+1,300 kcal

And, for natural gas (methane):

CH₄+3O₂→CO₂+2H₂O+213 kcal

So, oxides of carbon (COx, CO and/or CO₂) are produced by the combustion of fossil fuels. It is generally believed among scientists that global warming is a result of a buildup of COₓ in the Earth's atmosphere. While photosynthesis will naturally turn CO₂ back into O₂, man-made production of CO₂ in combination with significant deforestation have left earth's plant life incapable of converting enough of manmade CO₂ back into O₂. This is while CO, an incomplete combustion by-product, is toxic to all human, animal and plant life.

In addition, hydrocarbon combustion creates NOₓ (NO, NO₂ and NO₃); NOₓ retards photosynthesis, while being toxic to all human, animal and plant life. This is while the formation of NOₓ is endothermic, thereby lessening combustion efficiency. Once formed, NOₓ further reacts with O₂ in the air to form ozone (O₃). O₃ is toxic to all human, animal and plant life. O₃ does protect the earth in the upper atmosphere from harmful U/V radiation; however, at the surface, O₃ is toxic to all life.

Liquid and solid hydrocarbons naturally contain sulfur (S) as a contaminant. In combustion, S is oxidized to SOₓ (SO₂, SO₃ and SO₄) which is also toxic to all human, animal and plant life.

Lastly, COₓ, NOₓ and SOₓ react with H₂O in the air to form acids, e.g. H₂CO₃, HNO₃ and H₂SO₄ which then literally rain acids upon the earth.

Hydrocarbon fuels have been modified with additives to minimize the formation of either COx or NOx. However, with all of the scrubber modifications, engine modifications and fuel modifications, the Earth is struggling to keep up. In addition to environmental issues, availability and dependability of large quantities of petroleum hydrocarbons has become a geopolitical issue.

There have been many previous attempts to produce a combustion engine that would operate with H₂ as the fuel and air as the oxidant. Those attempts had as difficulties: higher combustion temperatures, reduced available torque, increased NOₓ formation, a lack of H₂ storage capacity, excessive heat and cost of operation. Jet propulsion applications with H₂ as the fuel have had as difficulties: high combustion temperatures, lack of available thrust and a low altitude ceiling, thereby limiting use to kerosene. This is while, as compared to kerosene, H₂ has about three times the available combustion energy per pound. However, H₂ is much less dense than any hydrocarbon; H₂ is not a liquid until the temperature is lowered to near −423° F.; therefore, storage equipment for H₂ needs to be able to withstand high pressures and/or cryogenic temperatures. High pressure storage for large volumes of H₂ becomes economically impractical. A currently proposed technology for H₂ storage is metal hydrides. While promising, metal hydride storage systems have a high storage mass to fuel mass ratio while being rather expensive.

Historically, it has been believed that the electric motor is the solution to finding an environmentally friendly energy source. However, this concept has deficiencies in that the electrical energy required to power an electric motor must be created and stored. Electrical energy is most commonly created with at least one selected from a list consisting of 1) hydrocarbon combustion/steam generation processes, 2) photovoltaic generation processes, 3) H₂O driven generation processes, 4) windmill driven generation processes or 5) nuclear generation/steam driven generation processes. While the photovoltaic process is environmentally friendly, the photovoltaic process is not reliable or effective enough in many applications. While the H₂O driven (H₂O wheel) generation process is environmentally friendly, the H₂O driven generation process is a geographically limited source of energy. While the wind driven generation processes are environmentally friendly, wind is a limited non-reliable resource. While the nuclear generation driven generation process is environmentally friendly, concerns over the safety of such installations have limited their application.

Previous and current attempts to produce a fuel cell that would operate on H₂ and air, or on a hydrocarbon and air, are showing promising results. However, the capital investment to power output ratio for fuel cells is 300 to 500 percent of that for traditional hydrocarbon combustion. Also, the increased maintenance requirement of fuel cells is 100 to 300 percent of that for combustion. In addition, fuel cells require Platinum, wherein there is not enough Platinum in the Earth's crust for a few year's automotive production. There is certainly not enough Platinum on Earth to meet world energy needs. Lastly, in transportation, the fuel cell does not have the same “feel” as an internal combustion engine, which will lead to acceptance challenges. Previous attempts to replace or reduce the power of the internal combustion engine have failed due to market acceptance. Auto enthusiasts have come to enjoy and expect the “feel” and the power of the internal combustion engine.

Prior to this instant invention, previous work in the WCT is referenced herein in U.S. application Ser. No. 10/790,316, PCT/US 03/11250 and PCT/US 03/41719.

Previous work to develop a combustion engine prior to the WCT that would operate on fuel(s) other than hydrocarbon(s) is referenced herein in U.S. Pat. No. 3,884,262, U.S. Pat. No. 3,982,878, U.S. Pat. No. 4,167,919, U.S. Pat. No. 4,308,844, U.S. Pat. No. 4,599,865 U.S. Pat. No. 5,775,091, U.S. Pat. No. 5,293,857, U.S. Pat. No. 5,782,081, U.S. Pat. No. 5,775,091 and U.S. Pat. No. 6,290,184. The closest work to this instant invention is U.S. Pat. No. 6,289,666 B1. While each of these patents present improvements in combustion technology, each leaves issues that have left the commercialization of such a combustion engine impractical.

Combustion Engine Thermodynamics—Much has been much done mechanically and chemically to combat the environmental issues associated with hydrocarbon combustion. Often, industrial facilities are outfitted with expensive scrubber systems whenever the politics demand installation and/or the business supports installation. As another example, the internal combustion engine has been enhanced significantly to make the engine more fuel efficient and environmentally friendly. However, even with enhancement, the internal combustion engine is only approximately 20 percent efficient and the gas turbine/steam turbine system is only approximately 20 to 40 percent efficient. The internal combustion engine looses as a percentage of available energy fuel value: 1) approximately 35 percent in the exhaust, 2) approximately 35 percent in cooling, 3) approximately 9 percent in friction, and 4) approximately 3 percent due to combustion performance, leaving the engine approximately less than 20 percent efficient.

An internal combustion engine produces power to perform work as a result of a complex series of interactions among “Billions and billions of molecules on a microscopic scale.” (quoting Carl Sagan) Thermodynamics is a branch of engineering, chemistry and physics that allows one to reduce this chaotic process to a relatively simple system based on the behavior of these molecules in the aggregate or, in other words, on a macroscopic scale.

For example, each molecule of a gas flies around with a speed that is a function of its particular temperature. Thermodynamics allows one to assign a single temperature to an entire volume of gas molecules based on the average temperature of all the molecules. Other macroscopic variables used to describe the behavior of a gas are the pressure within the enclosing container, the volume of the container and the number of molecules of gas present. The relationship between these variables can be approximated by the ideal gas law:

PV=nRT

where P, V and T are the absolute pressure, volume and absolute temperature, respectively. N (n) is the number of moles of gas (1 mole=6.023×10²³ molecules) and R is the universal gas constant (0.0821 liter-atmosphere/mole-K).

There are three basic laws of thermodynamics. The first, called the zeroth, law states that if object A is in thermal equilibrium with object B and object B is in thermal equilibrium with object C then object A and object C will also be in thermal equilibrium. This law is the basis of thermometry in which a thermometer can be used to compare the temperature of one object with another.

The next law, which is called the first law in the traditional numbering scheme, states that the change in the internal energy of a system is equal to the sum of the heat transferred from the system, the entropy transferred from the system and the amount of work done by the system. In other words, any thermal energy transferred into a system can be used to change the internal energy of that system (by changing its temperature) or to perform external work. This is a statement of the law of conservation of energy for thermal processes.

The final law, the second, essentially says that any heat engine cannot convert all of the energy put in to it to useful work. There will always be some waste heat left over.

A system's temperature is a measure of its internal energy. If heat is added to a volume of gas molecules and the system does not perform any external work the relationship between the heat added and the temperature can be described by:

Q=nCᵥΔT or Q=nCₚΔT,

wherein: Q is the amount of heat transferred, n is the number of moles of gas present, ΔT is the temperature change, and Cᵥ, as well as Cₚ are called the specific heat at constant volume and the specific heat at constant pressure, respectively, which depend on the type of gas. The first equation applies if the process takes place without a change in volume (a constant volume or isochoric process) and the second equation applies if the process takes places at constant pressure (a constant pressure or isobaric process).

The work done by a system can be found by multiplying the component of the force exerted in the direction of motion times the distance moved. For more complex systems where the force may not be constant the work can be calculated using calculus by integrating the following equation:

dW=Fdx,

wherein: dW is the increment of work, F is force and dx is the incremental distance moved. For a machine consisting of a piston in a closed cylinder the force exerted against the piston is given by the product of the pressure in the cylinder, P, and the area of the piston, A, e.g.

dW=PAdx.

Note that the term Adx is just the amount the volume of the closed cylinder changes when the piston moves a distance dx so the equation can be rewritten as:

dW=PdV.

In order to integrate this equation it is necessary to know the relationship between pressure and volume for the process. Such relationships can be displayed on a P-V diagram which is a plot with P as the vertical axis and V as the horizontal axis. There are a number of standard P-V processes illustrated on FIG. 2. The solid black line represents an isothermal expansion from 1 liter to 5 liters. The equation describing this curve is the ideal gas law:

PV=nRT,

wherein: P is the absolute pressure, V the volume, n is the number of moles of gas present, R is the universal gas constant and T is the absolute temperature. Isothermal means that the temperature is constant during the process. The work done by the system during the expansion can be calculated by integrating the work equation with the P replaced by a function of V from the governing ideal gas law:

$$W = \int P d V = nRT {\int }_{1}^{5} \frac{1}{V} d V .$$

Notice that this integral represents the area on the P-V diagram that lies under the isothermal curve.

The gray curve represents an adiabatic expansion from 1 to 5 liters. Adiabatic means that no heat is transferred during the process. Notice that the adiabatic curve is steeper than the isothermal curve. The relationship between pressure and volume for an adiabatic curve is given by the following equation:

PV^{γ}=constant

where, γ is the ratio of specific heat at constant pressure to the specific heat at constant volume (Cₚ/Cᵥ) for the contained gas with a typical value of 1.4 for the types of gases involved in gasoline combustion engines. Generally, an isothermal process occurs slowly so heat can be transferred into or out of the system to maintain the constant temperature. An adiabatic process, by contrast, generally occurs rapidly so heat does not have a chance to flow.

The dotted black line describes an isobaric (constant pressure) process. The work done during this process is simply:

W=P×(V_{f}−Vᵢ)

The final dotted grey line represents an isochoric (constant volume) process. Since the area under this curve is zero no work is done.

FIG. 3 represents a cyclic process for a theoretical system called a Carnot engine. Path a to b is an isothermal compression at 400K. Path b to c is an adiabatic compression. Path c to d is an isothermal expansion at 600K and d back to a is an adiabatic expansion. The four paths define a closed path in P-V space. The enclosed area is the net work performed by the engine for each completed cycle around the clockwise path described. If the path had been in the counter clockwise direction the net work would have been negative.

FIG. 4 presents the Otto Cycle, which approximates the operation of a gasoline-powered internal combustion engine. Path a to b represents the intake stroke during which the air-fuel mixture is drawn into the cylinder as the piston moves outward. This process occurs at roughly atmospheric pressure (assuming a normally aspirated engine). Next, the intake valve closes and the piston moves inward compressing the mixture along the path from b to c. This is an adiabatic process since it happens fairly quickly. Work is done on the gas and its internal energy increases.

At the end of the compression stroke the mixture is ignited and the pressure increases rapidly along the path from c to d. This process happens very quickly and is essentially a nearly pure isochoric (constant volume) process. No work is done during this process so the heat of combustion goes entirely into raising the internal energy of the constituent gases. The power stroke is next and is an adiabatic expansion from d to e. During this process the system does external work and the internal energy decreases. At the end of the power stroke the exhaust valve is opened and the exhaust gases escape very quickly in what is essentially another isochoric process moving along path e to b. Finally, the piston again moves inward forcing out the remaining exhaust gases at atmospheric pressure along the path b to a. And the cycle repeats . . . .

The net work performed by the Otto Engine is given by the area enclosed by the four paths b to c to d to e to b. The work done during the intake and exhaust strokes (the areas under paths a to b and b to a) cancel each other.

A Hypothetical Gasoline Engine—Let us consider the following hypothetical gasoline engine in order to put some actual numbers to the Otto cycle described previously. Let us have 6 cylinders with 100 mm bore and 78.9 mm stroke and a compression radon of 10; then:

1. Compression
During the compression stroke:

$$Engine displacement = π \cdot {( \frac{bore}{2} )}^{2} \cdot ( stroke ) \cdot ( \# of cyls . )$$

Displacement per cylinder=π·(50 mm)²·(78.9 mm)=620 cm³(0.621)

$$Compression ratio = c . r . = \frac{displacement + dead space}{dead space}$$

The dead space (volume remaining when the piston is fully inserted) can be calculated from the following equation:

$$c . r . = 10.0 = \frac{620 + d . s .}{d . s .} \to 69 {mm}^{3} ( 0.069 l )$$

For simplicity, 0.069 L≈0.070 L for the dead space.
The number of moles of gas (air and gasoline vapor) in the cylinder at the beginning of the compression stroke from the ideal gas law.

$$n = \frac{P \cdot V}{n \cdot R}$$

$$n = \frac{( 1.0 atm ) \cdot ( 0.69 l )}{( 0.0821 l - atm \text{/} mole - K ) \cdot ( 300 K )} = 0.0280 moles$$

The pressure in the cylinder at the end of the compression stroke (P, V) can be calculated from the pressure and volume at the beginning of the compression stroke (P₀, V₀) as follows:

$$P \cdot {V}^{γ} = constant = {P}_{0} \cdot {V}_{0}^{γ}$$

$$P = {P}_{0} \cdot {( \frac{{V}_{0}}{V} )}^{γ}$$

$$P = ( 1.0 atm ) \cdot {( \frac{0.690 l}{0.070 l} )}^{1.4} = 24.6 atm$$

The temperature after compression is given by the ideal gas law:

$$T = \frac{PV}{nR} = \frac{( 24.6 atm ) \cdot ( 0.070 l )}{( 0.028 moles ) \cdot ( 0.0821 l \cdot atm \text{/} mole \cdot K )} = 749 K$$

The resulting curve is shown in FIG. 5.

2. Combustion
The chemical reaction between gasoline and air can be simplified as follows:

C₈H₁₈+12.5O₂→8CO₂+9H₂O+1300 kcal(5443 kJ)
Just prior to combustion there are 0.0280 moles of gas present in the cylinder. This gas is a mixture of gasoline vapor, O₂ and N₂. The O₂ and N₂ came from air which is approximately 21% O₂ and 79% N₂. The ratio of gasoline vapor to O₂ is given in the above equation. So a single equation can relate the relative amounts of all three gases present. If x represents the number of moles of air in the cylinder, then:

$$moles of {N}_{2} = 0.79 \cdot x$$

$$moles of {O}_{2} = 0.21 \cdot x$$

$$moles of {C}_{8} {H}_{18} = \frac{1}{12.5} \cdot 0.21 \cdot x$$

The total number of moles is 0.0280 so x can be determined from the following equation:

$$\frac{1}{12.5} \cdot ( 0.21 ) \cdot x + ( 0.21 ) \cdot x + ( 0.79 ) \cdot x = 0.0280 moles$$

The result is 0.0275 moles of air. Inserting this value of x in the previous series of equations yields: 0.0005 moles of C₈H₁₈, 0.0058 moles of O₂ and 0.0218 moles of N₂. From the chemical equation describing the combustion of gasoline and the number of moles of reactants we can calculate the number of moles of each of the reaction products. Each 12.5 moles of O₂ produces 8 moles of CO₂ and 9 moles of H₂O.

$$( 0.0058 moles {O}_{2} ) \cdot \frac{8 moles {CO}_{2}}{12.5 moles {O}_{2}} = 0.0037 moles {CO}_{2} \\ ( 0.0058 moles {O}_{2} ) \cdot \frac{9 moles {H}_{2} O}{12.5 moles {O}_{2}} = 0.0042 moles {H}_{2} O$$

Since one mole of gasoline reacting with O₂ yields 5443 kJ, the above reaction of 0.0005 moles will yield 2.5 kJ of energy. No work is done during this process so the first law of thermodynamics requires this energy to be stored as internal energy of the reaction products which will raise their temperatures in proportion to the number of moles present and the specific heats of each gas. The heat capacities (in this case the molar-specific heats at constant volume) and number of moles (from the above formula) are as follows:

| Gas | Number of Moles | Heat Capacity | Units |
|---|---|---|---|
| N₂ | 0.0218 | 25.8 | J/mole-K |
| CO₂ | 0.0037 | 40.8 | J/mole-K |
| H₂O | 0.0042 | 37.0 | J/mole-K |

The temperature rise can then be calculated using the following equation:

Q=n_{N}_{₂}·C_{V,N}_{₂}·ΔT+n_{CO}_{₂}·C_{V,CO}_{₂}·ΔT+n_{H}_{₂}_{O}·C_{V,H}_{₂}_{O}·ΔT
Rearranging the equation to solve for ΔT and inserting appropriate values:

ΔT=Q/(n_{N}_{₂}·C_{V,N}_{₂}+n_{CO}_{₂}·C_{V,CO}_{₂}+n_{H}_{₂}_{O}·C_{V,H}_{₂}_{O})

ΔT=2.5 kJ/(0.02176·25.8+0.00368·40.8+0.00414·37.0)=2891 K

T=749 K+2891 K=3640 K
The pressure at the end of combustion can be calculated using the ideal gas law:

$$Pressure = \frac{n \cdot R \cdot T}{V}$$

$$\begin{matrix}Pressure = \frac{( 0.02958 moles ) \cdot ( 0.0821 l - atm / mole - K ) \cdot ( 3640 K )}{0.070 l} \\ = 126.3 atm ( 1856 psi )\end{matrix}$$

The increase in pressure from 24.6 atm to 126.3 atm, at Cv, is plotted in FIG. 5.

3. Expansion
Having computed the pressure at the beginning of the expansion stroke (and knowing the volume) it is possible to calculate the pressure as a function of volume during the adiabatic expansion:

$$P = {P}_{0} \cdot {( \frac{{V}_{0}}{V} )}^{γ}$$

$$P = ( 126.3 atm ) \cdot {( \frac{0.070 l}{V} )}^{1.4}$$

This line is plotted in the grey line on the P-V diagram.

4. Exhaust
The exhaust stroke is plotted in FIG. 5.

5. Work Performed
Work is only done by (or on) the system during the adiabatic processes (when the piston is actually moving) which can be calculated as follows:

$$W = \int P \cdot d V$$

$$P \cdot {V}^{γ} = {P}_{0} \cdot {V}_{0}^{γ}$$

$$W = \int {{P}_{0} ( \frac{{V}_{0}}{V} )}^{γ} \cdot d V$$

$$W = \frac{{P}_{0} \cdot V}{1 - γ} {( \frac{{V}_{0}}{V} )}^{γ} {\vert}_{{V}_{I}}^{{V}_{\int }}$$

Values for evaluating this integral are:

| Parameter | Compression | Expansion | Units |
|---|---|---|---|
| P₀ | 1.0 | 126.3 | atm¹ |
| V₀ (Vᵢ) | 0.690 | 0.070 | L² |
| Vf | 0.070 | 0.690 | L |
| Work | −2.58 | 13.25 | L-atm |

¹atm = atmosphere of pressure;
²L = Liter of volume

The work done during the expansion is 13.25 L-atm and the work done during the compression is −2.58 L-atm. The net work performed during each cycle is 10.67 L-atm (1.08 kJ).

6. Total Horsepower
For a typical automobile traveling at 60 MPH the engine speed is approximately 3000 rpm or 50 revolutions per second. Since a four stroke cylinder has a power stroke only every other revolution it will be firing at a rate of 25 power strokes per second. A six-cylinder engine will have 150 power strokes per second. Thus, the total power will be:

(150 power strokes/sec)·(1.08 kJ/stroke)/0.746 kW/hp=217 hp
However, there are a whole host of effects that take this energy away such as friction, inefficient combustion, heat losses, entropy losses and accelerating inertial masses. This can easily take up 80 to 85% of the power leaving only about 35 to 45 hp delivered to the rear wheels (at 60 MPH).
   O₂—While there are many methods to prepare O₂, the separation of air into its component gases is industrially performed by three methods: cryogenic distillation, membrane separation and SA.

Cryogenic distillation incorporates cryogenic refrigeration, wherein there are many known methods of cryogenic refrigeration. A good reference of cryogenic refrigeration methods and processes known in the art would be “Cryogenic Engineering,” written by Thomas M. Flynn and printed by Dekker. As written by Flynn, “cryogenic refrigeration and liquefaction are the same processes, except liquefaction takes off a portion of the refrigerated liquid which must be made up, wherein refrigeration all of the liquid is recycled. All of the methods and processes of refrigeration and liquefaction are based upon the same basic refrigeration principals, as depicted in Flow Diagram 1.

As written by Flynn, there are many ways to combine the few components of work (compression), rejecting heat, expansion and absorbing heat. There exist in the art many methods and processes of cryogenic refrigeration, all of which can be adapted for cryogenic liquefaction. A listing of those refrigeration cycles would include: Joule Thompson, Sterling, Brayton, Claude, Linde, Hampson, Postle, Ericsson, Gifford-McMahon and Vuilleumier. As written by Flynn, “There are as many ways to combine these few components as there are engineers to combine them.” (It is important to note, as is known in the art, that H₂ has a negative Joule-Thompson coefficient until temperatures of approximately 350 R or less are obtained.)

The distillation of air, a ternary mixture of O₂, N₂ and Ar₂ may be viewed as two binary distillations. One binary distillation is the separation of the high boiling point O₂ from the intermediate boiling point Ar₂. The other binary distillation is the separation of the intermediate boiling point Ar₂ from the low boiling point N₂. Of these two binary distillations, the former is more difficult, requiring more reflux and/or theoretical trays than the latter. Ar₂—O₂ separation is the primary function of third fractionating zone and the bottom section of the second fractionating zone below the point where the feed to the third zone is withdrawn. N₂ separation is the primary function of the upper section of the second fractionating zone above the point where the feed to the third fractionating zone is withdrawn.

Conventional cryogenic air distillation processes that separate air into O₂, Ar₂ and N₂ are commonly based on a dual pressure cycle. Air is first compressed and subsequently cooled. Cooling may be accomplished by one of four methods: 1—Vaporization of a liquid, 2—The Joule Thompson Effect (which performs best when augmented with method 3), 3—Counter-current heat exchange with previously cooled warming product streams or with externally cooled warming product streams and 4—The expansion of a gas in an engine doing external work. The cooled and compressed air is usually introduced into two fractionating zones. The first fractionating zone is thermally linked with a second fractionating zone which is at a lower pressure. The two zones are normally thermally linked such that a condenser of the first zone reboils the second zone. The air undergoes a partial distillation in the first zone producing a substantially pure N₂ fraction and a liquid fraction that is enriched in O₂. The enriched O₂ fraction is normally an intermediate feed to the second fractionating zone. The substantially pure liquid N₂ from the first fractionating zone is used as reflux at the top of the second fractionating zone. In the second fractionating zone separation is completed, producing substantially pure O₂ from the bottom of the zone and substantially pure N₂ from the top. When Ar₂ is produced in the conventional process, a third fractionating zone is employed. The feed to this zone is a vapor fraction enriched in Ar₂ which is withdrawn from an intermediate point in the second fractionating zone. The pressure of this third zone is of the same order as that of the second zone. In the third fractionating zone, the feed is rectified into an Ar₂ rich stream which is withdrawn from the top, and wherein a liquid stream which is withdrawn from the bottom of the third fractionating zone is introduced to the second fractionating zone at an intermediate point. Reflux for the third fractionating zone is provided by a condenser which is located at the top. In this condenser, Ar₂ enriched vapor is condensed by heat exchange from another stream, which is typically the enriched O₂ fraction from the first fractionating zone. The enriched O₂ stream then enters the second fractionating zone in a partially vaporized state at an intermediate point, above the point where the feed to third fractionating zone is withdrawn.

The ease of distillation is also a function of pressure. Both binary separations become more difficult at higher pressure. This fact dictates that for the conventional arrangement the optimal operating pressure of the second and third fractionating zones is at or near the minimal pressure of one atmosphere. For the conventional arrangement, product recoveries decrease substantially as the operating pressure is increased above one atmosphere mainly due to the increasing difficulty of the Ar₂—O₂ separation. There are other considerations, however, which make elevated pressure processing attractive. Distillation column diameters and heat exchanger cross sectional areas can be decreased due to increased vapor density. Elevated pressure products can provide substantial compression equipment capital cost savings. In some cases, integration of the air separation process with a power generating gas turbine is desired. In these cases, elevated pressure operation of the air separation process is required. The air feed to the first fractionating zone is at an elevated pressure of approximately 10 to 20 atmospheres absolute. This causes the operating pressure of the second and third fractionating zones to be approximately 3 to 6 atmospheres absolute.

As used herein: the term “indirect heat exchange” means the bringing of two fluid streams into heat exchange relation without any physical contact or intermixing of the fluids; the term “air” means a mixture comprising primarily O₂, N₂ and Ar₂; the terms “upper portion” and “lower portion” mean those sections of a column respectively above and below the midpoint of the column; the term “tray” means a contacting stage, which is not necessarily an equilibrium stage, and may mean other contacting apparatus such as packing having a separation capability equivalent to one tray; the term “equilibrium stage” means a vapor-liquid contacting stage whereby the vapor and liquid leaving the stage are in mass transfer equilibrium, e.g. a tray having 100 percent efficiency or a packing element height equivalent to one theoretical plate (HETP); the term “top condenser” means a heat exchange device which generates column down flow liquid from column top vapor, the term “bottom reboiler” means a heat exchange device which generates column upflow vapor from column bottom liquid. (A bottom reboiler may be physically within or outside a column. When the bottom reboiler is within a column, the bottom reboiler encompasses the portion of the column below the lowermost tray or equilibrium stage of the column.)

While it is well known in the chemical industry that the cryogenic distillation of air into O₂, N₂ and Ar₂; cryogenic distillation is the most economical pathway to produce these elemental diatomic gases. Previous work performed to separate air into its components is herein referenced in U.S. Pat. No. 4,112,875; U.S. Pat. No. 5,245,832; U.S. Pat. No. 5,976,273; U.S. Pat. No. 6,048,509; U.S. Pat. No. 6,082,136; U.S. Pat. No. 6,298,668 and U.S. Pat. No. 6,333,445.

It is also well known in many industries to separate air with membranes. Two general types of membranes are known in the am organic polymer membranes and inorganic membranes. These membrane separation processes are improved by setting up an electric potential across a membrane that has been designed to be electrically conductive. Previous work performed to separate air into its components with membranes is herein referenced in U.S. Pat. No. 5,599,383; U.S. Pat. No. 5,820,654; U.S. Pat. No. 6,277,483; U.S. Pat. No. 6,289,884; U.S. Pat. No. 6,298,664; U.S. Pat. No. 6,315,814; U.S. Pat. No. 6,321,915; U.S. Pat. No. 6,325,218; U.S. Pat. No. 6,340,381; U.S. Pat. No. 6,357,601; U.S. Pat. No. 6,360,524; U.S. Pat. No. 6,361,582; U.S. Pat. No. 6,361,583 and U.S. Pat. No. 6,372,020.

It is also known to separate air into its components with SA. Previous work performed to separate air into its components with SA is herein referenced in U.S. Pat. No. 3,140,931; U.S. Pat. No. 3,140,932; U.S. Pat. No. 3,140,933; U.S. Pat. No. 3,313,091; U.S. Pat. No. 4,481,018; U.S. Pat. No. 4,557,736; U.S. Pat. No. 4,859,217; U.S. Pat. No. 5,464,467; U.S. Pat. No. 6,183,709 and U.S. Pat. No. 6,284,201.

Steam Conversion—The discovered WCT Instant Invention relates to producing H₂ from steam, since steam is the physical state of the H₂O product from combustion. Previous work in this field has focused on refinery or power plant exhaust gases; none of that work discusses the separation of steam back into H₂. Previous work performed to utilize the products of hydrocarbon combustion from an internal combustion engine can be referenced in U.S. Pat. No. 4,003,343. Previous work in corrosion is in the direction of preventing corrosion instead of encouraging corrosion, yet is herein referenced in U.S. Pat. No. 6,315,876, U.S. Pat. No. 6,320,395, U.S. Pat. No. 6,331,243, U.S. Pat. No. 6,346,188, U.S. Pat. No. 6,348,143 and U.S. Pat. No. 6,358,397.
Electrolysis—The discovered WCT Instant Invention relates to electro-chemically converting H₂O into O₂ and H₂. While there have been improvements in the technology of electrolysis and there have been many attempts to incorporate electrolysis with a combustion engine, wherein the hydrocarbon fuel is supplemented by H₂ produced by electrolysis, there has been no work with electrolysis to fuel a combustion engine wherein electrolysis is a significant source of O₂ and H₂. Previous work in electrolysis as electrolysis relate to combustion systems is herein referenced in U.S. Pat. No. 6,336,430, U.S. Pat. No. 6,338,786, U.S. Pat. No. 6,361,893, U.S. Pat. No. 6,365,026, U.S. Pat. No. 20 6,635,032 and U.S. Pat. No. 4,003,035.
Electricity—The discovered WCT Instant Invention relates to the production of electricity. The mechanical energy to turn a generator (again, a generator means a generator, alternator or dynamo) is produced by the WCT Instant Invention. This is while the steam energy for a steam driven generator may be produced by the WCT Instant Invention; WCT Instant Invention exhaust steam energy may drive a steam turbine, thereby turning a generator to create an electrical current.

The discovered WCT Instant Invention presents a combustion turbine, wherein the exhaust gas is at least primarily if not totally H₂O or H₂O and air. While there has been much work in the design of steam turbines, in all cases steam for the steam turbine is generated by heat transfer, wherein said heat for heat transfer is created by nuclear fission or hydrocarbon combustion. Previous work in steam turbine generation technology and exhaust turbine technology is herein referenced in: U.S. Pat. No. 6,100,600, U.S. Pat. No. 6,305,901, U.S. Pat. No. 6,332,754. U.S. Pat. No. 6,341,941, U.S. Pat. No. 6,345,952, U.S. Pat. No. 4,003,035, U.S. Pat. No. 6,298,651, U.S. Pat. No. 6,354,798, U.S. Pat. No. 6,357,235, U.S. Pat. No. 6,358,004 and U.S. Pat. No. 6,363,710, the closest being U.S. Pat. No. 4,094,148 and U.S. Pat. No. 6,286,315 B1.

The discovered WCT Instant Invention relates to air and H₂O driven turbine technologies to create electricity. Air or H₂O driven turbine electrical generation technology would be applicable to combustion system(s) utilizing the discovered WCT Instant Invention, wherein: there is a reliable source of moving air and/or H₂O to generate electricity for the electrolysis of water. Previous work in wind driven generator technology is herein referenced in U.S. Pat. No. 3,995,972, U.S. Pat. No. 4,024,409, U.S. Pat. No. 5,709,419, U.S. Pat. No. 6,132,172, U.S. Pat. No. 6,153,944, U.S. Pat. No. 6,224,338, U.S. Pat. No. 6,232,673, U.S. Pat. No. 6,239,506, U.S. Pat. No. 6,247,897, U.S. Pat. No. 6,270,308, U.S. Pat. No. 6,273,680, US 293,835, 15 U.S. Pat. No. 294,844, U.S. Pat. No. 6,302,652, U.S. Pat. No. 6,323,572, and U.S. Pat. No. 6,635,981.

The discovered WCT Instant Invention relates to photovoltaic means to create electricity, wherein said electricity is used in electrolysis to create at least one of H₂ and O₂ from H₂O, and wherein said H₂ and/or said O₂ is used as a fuel in said WCT Instant Invention. There are many means of photovoltaics, as is known in the art. There are many means wherein a photovoltaic cell may be used to create electricity for the electrolytic separation of H₂O into H₂ and O₂. Previous work in photovoltaic cells in relation to the production of H₂ is herein referenced in: U.S. Pat. No. 5,797,997, U.S. Pat. No. 5,900,330, U.S. Pat. No. 5,986,206, U.S. Pat. No. 6,075,203, U.S. Pat. No. 6,128,903, U.S. Pat. No. 6,166,397, U.S. Pat. No. 6,172,296, U.S. Pat. No. 6,211,643, U.S. Pat. No. 6,214,636, U.S. Pat. No. 6,279,321, U.S. Pat. No. 6,372,978, U.S. Pat. No. 6,459,231, U.S. Pat. No. 6,471,834, U.S. Pat. No. 6,489,553, U.S. Pat. No. 25 6,503,648, U.S. Pat. No. 6,508,929, U.S. Pat. No. 6,515,219 and U.S. Pat. No. 6,515,283.

H₂O Treatment Chemistry—The discovered WCT Instant Invention relates to methods of controlling corrosion, scale and deposition in H₂O applications. U.S. Pat. No. 4,209,398 issued to Ii, et al., on Jun. 24, 1980, referenced herein, presents a process for treating H₂O to inhibit formation of scale and deposits on surfaces in contact with the H₂O and to minimize corrosion of the surfaces. The Ii, et al. process comprises mixing in the H₂O an effective amount of H₂O soluble polymer containing a structural unit that is derived from a monomer having an ethylenically unsaturated bond and having one or more carboxyl radicals, at least a part of said carboxyl radicals being modified, and one or more corrosion inhibitor compounds selected from the group consisting of inorganic phosphoric acids and H₂O soluble salts therefore. Phosphoric acids and H₂O soluble salts thereof, organic phosphoric adds and H₂O soluble salts thereof, organic phosphoric acid esters and H₂O-soluble salts thereof and polyvalent metal salts, capable of being dissociated to polyvalent metal ions in H₂O.

U.S. Pat. No. 4,442,009 issued to O'Leary, et al., on Apr. 10, 1984, referenced herein, presents a method for controlling scale formed from H₂O soluble calcium, magnesium and iron impurities contained in boiler H₂O. The method comprises adding to the H₂O a chelant and H₂O soluble salts thereof, a H₂O soluble phosphate salt and a H₂O soluble poly methacrylic acid or H₂O soluble salt thereof.

U.S. Pat. No. 4,631,131 issued to Cuisia, et al., on Dec. 23, 1986, referenced herein, presents a method for inhibiting formation of scale in an aqueous steam generating boiler system. Said method comprises a chemical treatment consisting essentially of adding to the H₂O in the boiler system scale-inhibiting amounts of a composition comprising a copolymer of maleic acid and alkyl sulfonic acid or a H₂O soluble salt thereof; hydroxyl ethylidene, 1-diphosphic acid or a H₂O soluble salt thereof and a H₂O soluble sodium phosphate hardness precipitating agent.

U.S. Pat. No. 4,640,793 issued to Persinski, et al., on Feb. 3, 1987, referenced herein, presents an admixture, and its use in inhibiting scale and corrosion in aqueous systems, comprising. (a) a H₂O soluble polymer having a weight average molecular weight of less than 25,000 comprising an unsaturated carboxylic acid and an unsaturated sulfonic acid, or their salts, having a ratio of 1:20 to 20:1, and (b) at least one compound selected from the group consisting of H₂O soluble polycarboxylates, phosphonates, phosphates, polyphosphates, metal salts and sulfonates. The Persinski patent presents chemical combinations which prevent scale and corrosion.

In summary, COx, NOx, SOₓ and O₃ are direct and indirect products of the combustion of hydrocarbons. These products adversely affect: all life, our environment and the health of our Earth. An environmentally acceptable alternative would be an energy combustion system which works in concert with nature. The WCT Instant Invention presents itself to be that alternative.

### SUMMARY OF THE INVENTION

A primary object of the invention is to devise environmentally friendly, effective, efficient and economically feasible combustion methods, processes, systems and apparatus, wherein engine power, effectiveness and efficiency are improved.

Another object of the invention is to devise environmentally friendly, effective, efficient and economically feasible combustion means for an internal combustion engine.

Still another object of the invention is to devise environmentally friendly, effective, efficient and economically feasible combustion means for electrical energy generation.

Still further, another object of the invention is to devise effective, efficient and economically feasible combustion means that do not produce oxides of carbon.

Still further yet, another object of the invention is to devise effective, efficient and economically feasible combustion means that minimise the production of oxides of N₂.

Further yet still, another object of the invention is to devise effective, efficient and economically feasible fuel system for an environmentally friendly, effective and efficient combustion methods, processes, systems and apparatus.

Still also further, another object of the invention is to devise effective, efficient and economically feasible fuel and cooling means for environmentally friendly, effective and efficient electricity production.

Still further yet also, another object of the invention is to devise effective, efficient and economically feasible combustion means that include H₂ and O₂, wherein the temperature of combustion is controlled so that economical materials of construction for a combustion engine can be used.

Still also further yet, another object of the invention is to devise effective, efficient and economically feasible means of increasing the efficiency of combustion.

And still also further yet, another object of the invention is to devise effective, efficient and economically feasible electrolytic means to convert H₂O into O₂ and H₂ utilizing the energy available from combustion.

Another object of the invention is to devise effective, efficient and economically feasible catalytic means for the conversion of stream into H₂, wherein said steam is produced by a combustion engine that is fueled by O₂ and H₂.

Additional objects and advantages of the invention will be set forth in part in a description which follows and in part will be obvious from the description, or may be learned by practice of the invention.

An improved environmentally friendly process to create energy over that of the combustion of fossil fuels would be a process that does not produce a product of which the earth would have to naturally remove or convert. The Earth is covered mostly by H₂O. H₂O is made by the combustion of O₂ and H₂. This instant invention incorporates at least one of enriched, pure and very pure O₂, which is obtained by at least one selected from a list consisting of: liquefaction (cryogenic distillation) of air; membrane separation of air; Swing Adsorption (SA) of air and electrolysis of H₂O.

The instant invention manages energy much more efficiently than the traditional combustion engine, which operates with hydrocarbons and air. This is especially the case with respect to the internal combustion engine (ICE). ICE, generally, looses approximately 60 to 85 percent of available combustion energy in: heat losses from the engine, engine exhaust gases and unused mechanical energy. In contrast, the instant invention recaptures significant energy losses by converting lost energy (enthalpy and entropy) into potential energy and internal energy. In contrast the instant invention generates additional power by utilizing the power of steam to increase engine efficiency while using H₂O and the release of said steam to cool the engine. It is further discovered that this instant invention provides the thermodynamic capability to improve combustion efficiency while providing improved engine performance, wherein said improved engine performance relates to both the produced engine power and the available power produced per cubic inch of engine displacement.

The discovered WCT Instant Invention utilizes the energy of combustion of H₂ with at least one of enriched, pure and very pure O₂ as the oxidizer for combustion. In the alternative, the WCT Instant Invention utilizes the combustion of H₂ with an excess of air over that required to perform combustion such that the temperature of combustion is reduced by said excess of air, thereby minimizing NOₓ formation. The combustion of H₂ with O₂ provides a combustion envelope having attributes which are somewhat different than those for any hydrocarbon. In comparison and contrast, the auto-ignition (combustion without a spark) temperature of H₂ is 585° C., while that of methane and propane is 540 and 487° C., respectively. The combustion envelope, by volume, for H₂ in air is near 4-75% (air is near 20% O₂), while that of methane and propane is near 5.3-15% and 2.1-9.5%, respectively. The explosive regions for H₂ and methane are 13-59% and 6.3-14%, respectively. It has, therefore, been discovered in the WCT Instant Invention that H₂ provides a combustion envelope which allows for a cooling of combustion and of combustion exhaust gases, wherein said combustion envelope is not available with a hydrocarbon.

The combustion product of H₂ and O₂ is H₂O. This combustion reaction is somewhat similar to that of hydrocarbon combustion; however, carbon is removed from the reaction, while N₂ is partially or totally removed by the WCT Instant Invention. Further, H₂ as a fuel will not contain any appreciable amount of sulfur. In conclusion, the combustion of H₂ with near pure O₂ produces near pure H₂O, which is in stark contrast to the combustion of fossil fuels which produce in addition to H₂O oxides of carbon (COₓ) oxides of N₂ (NOₓ) and whenever the hydrocarbon is contaminated with S, oxides of sulfur (SO_{X}).

The discovered WCT uses the first and second laws of thermodynamics as an asset. In contrast, hydrocarbon combustion technologies have the first and second laws of thermodynamics as a liability. Specifically:

Combustion Energy=Available Work+Combustion Losses Friction Energy Losses+Enthalpy Losses+Entropy Losses+Potential Energy,

which can be rewritten as:

Combustion Energy=Available Work+Combustion Losses+Friction Energy Losses+Heat and Cooling losses+Exhaust losses+Potential Energy,

And, in the case of most hydrocarbon combustion systems:

Combustion Energy=(15-20%)+(1-5%)+(5-15%)+≈35%+≈35%+0,

leaving only about 15 to 20% of combustion energy available for work.

In comparison and contrast the discovered WCT Instant Invention operates with an insulated combustion chamber or engine block and a recycling of exhaust gas energy, thereby redefining the thermodynamics of combustion to be approximated by:

Combustion Energy(100%)=Available Work+Friction Energy Losses+Recycled Energy Losses+Potential Energy

Therefore, 100%=(15 to 20%)+(1-5%)+(5-15%)+(5-40%)+Potential Energy. And, Potential Energy=25-75% excluding recycle losses, thereby producing a final engine efficiency of approximately 40 to 90% by incorporating the available potential energy of recycle. A preferred energy flow diagram for the WCT Instant Invention is depicted in FIG. 6.

The instant invention furthers engine efficiency by adding H₂O to the combustion chamber at least once in an internal combustion engine during at least one cycle to cool the engine, thereby creating steam, and thereby further powering the engine. It is a preferred embodiment of the instant invention within an internal combustion engine to have at least one cycle wherein no fuel (H₂) or oxidizer (O₂) is added to the combustion chamber, wherein H₂O is added as either a low pressure gas (steam) or as a liquid (H₂O), wherein the heat of the combustion chamber is transferred into said H₂O thereby cooling said combustion chamber and providing power due to the steam energy created by said heat transfer. It is a preferred embodiment of the instant invention within a turbine to add H₂O as either a low pressure gas (steam) or as a liquid (H₂O) to at least one of the combustion chamber and the steam turbine, wherein the heat of at least one of the combustion chamber and the combustion product (steam) is transferred into said H₂O thereby cooling said combustion chamber and providing power due to the steam energy created by said heat transfer. The capability of the WCT Instant Invention to provide further power and cooling by the addition of H₂O in at least one cycle other than the combustion cycle in an internal combustion engine or to provide further power and cooling by the addition of H₂O to at least one location in a turbine is herein defined as “Energy Recovery Cooling”.

Further, as the discovered WCT Invention in one embodiment increases the concentration of oxidizer in combustion, preferably O₂, while reducing to eliminating N₂ in combustion, the effectiveness and efficiency of combustion is increased; as air, which is normally used as the oxidant in hydrocarbon systems, is only about 20% O₂ and about 80% N₂. Therefore it is discovered that the WCT Instant Invention has the capability of significantly increasing engine power per cubic inch of displacement (combustion volume). It is a preferred embodiment of the discovered WCT Instant Invention to provide at least one of enriched, pure and very pure O₂ to combustion.

Further still, WCT Instant Invention power capability is enhanced by the discovered capability of the WCT Instant Invention to provide at least one of fuel (H₂) and of oxidizer (O₂) to combustion under pressure. This discovered capability of the WCT Instant Invention provides a significant power capability which is not practical in a hydrocarbon combustion system. Specifically, a hydrocarbon combustion system must increase rpm to increase power, as the combustion chemistry within each revolution is limited by the availability of oxidizer, O₂, in air at atmospheric pressure. In contrast, the discovered WCT Instant Invention can provide at least one of enriched, pure and very pure O₂ to combustion under pressure, wherein said O₂ is preferably achieved from at least one of: cryogenic distillation, SA and membrane separation of air. Further, the discovered WCT Instant Invention in a preferred embodiment stores H₂ in a cryogenic state, wherein said cryogenic capability is preferably provided by available cryogenic N₂ from cryogenic distillation of air. It is it most preferred to store said cryogenic H₂ below its Joule Thompson Curve, thereby causing said H₂ to have a positive Joule Thompson coefficient (JtC) in order to provide further chilling and/or liquefaction of said H₂. While significantly improving the storage energy per unit volume, chilled or liquefied H₂ provides a discovered capability to provide H₂ to combustion under pressure. As the discovered WCT Instant Invention is preferred to provide to combustion under pressure at least one of H₂ and of O₂, the discovered WCT Instant Invention presents an engine which can increase power or available work about independent of rpm, as well as increase power or work directly dependant upon rpm. This discovered capability of the WCT Instant Invention presents an engine which has a torque curve which is at least partially independent of rpm, or on a diagram of torque vs. rpm, the capability of a vertical or near vertical torque curve or the capability of a torque curve wherein at least one portion of the torque curve is about vertical. Said torque curve having at least a portion of which is about vertical or has the capability to be vertical is herein termed the “WCT Torque Curve.”

Further yet, as the discovered WCT Instant Invention in another embodiment increases the amount of air to minimize combustion temperature, thereby minimizing formation of N₂ oxides (NOₓ). The environmental consequences of combustion are minimized in combustion systems wherein an excess of air is required to reduce and/or control combustion temperature.

Further yet still, the discovered WCT Instant Invention in yet another embodiment improves the previously known Otto cycle by the addition of H₂O to the combustion chamber during exhaust, thereby cooling the engine during exhaust prior to the next cycle. This addition of water during exhaust has the WCT Instant Invention the capability of increasing available work, P×V.

Further still yet, as the discovered WCT Instant Invention in still yet another preferred embodiment can operate “in diesel fashion” due to the auto-ignition temperature of H₂, which is near 585° C.; the discovered WCT Instant Invention has the capability to further manage the cycle by the addition of either H₂ (fuel) or O₂ (oxidizer) during combustion. This discovered capability of the WCT Instant Invention provides the ability of “a slow burn” during the power or expansion portion of the cycle. This slow burn capability of the WCT Instant Invention is herein termed the “Newsom burn”.

And further still yet, as the discovered WCT Instant Invention has the capability of managing engine power by H₂O addition to cool the engine during the exhaust stroke as well as the capability of providing at least one of H₂ and O₂ to combustion during power generation (In the case of an ICE, this would be the power stroke and in the case of a turbine this would be anytime during the combustion of fuel); therefore, the discovered WCT Instant Invention has the capability of significantly managing and/or manipulating the work (P-V) curves of an engine such that WCT Instant Invention can manipulate the net work output for each engine cycle relative to conventional internal combustion engines. This capability is depicted in FIGS. 7 and 8, wherein FIG. 7 depicts the preferred embodiment of a two cycle version and FIG. 8 depicts a preferred embodiment of a four cycle version; this WCT Instant Invention variant to the Otto cycle incorporating both H₂O cooling during exhaust and diesel like “slow burn” during power is defined in the instant invention defines a new combustion cycle termed the “Haase Cycle”.

### BRIEF DESCRIPTION OF THE DRAWINGS

A better understanding of the present invention can be obtained when the following descriptions of the preferred embodiments are considered in conjunction with the following drawings, in which:

FIG. 1 illustrates a legend for FIGS. 2 through 9.

FIG. 2 illustrates a graphical representation of various thermodynamic processes as functions of pressure and volume

FIG. 3 illustrates a graphical representation of the work, pressure-volume, diagram of a Carnot Cycle.

FIG. 4 illustrates a graphical representation of the work, pressure-volume, diagram for an Otto Cycle.

FIG. 5 illustrates a graphical representation of the work, pressure-volume, diagram for an Atypical Gasoline Engine.

FIG. 6 illustrates in block diagram form the preferred embodiment of the instant invention as the instant invention applies to ICE.

FIG. 7 illustrates a graphical representation of the work, pressure-volume, diagram for a 2 cycle variant of the Haase Cycle.

FIG. 8 illustrates a graphical representation of the work, pressure-volume, diagram for a 4 cycle variant of the Haase Cycle.

FIG. 9 illustrates a graphical representation of the work, pressure-volume, diagram for a 4 cycle variant of the WCT Instant Invention.

FIG. 10 presents a computer result of a Model, wherein T₀=100 K, the moles of H₂O range from 0.084 to 0.2521 and the moles of H₂ range from 0.005 to 0.016.

FIG. 11 presents a computer result of said Model, wherein T₀=200 K, the moles of H₂O range from 0.042 to 0.126 and the moles of H₂ range from 0.005 to 0.016.

FIG. 12 presents a computer result of said Model, wherein T₀=300 K, the moles of H₂O range from 0.028 to 0.084 and the moles of H₂ range from 0.005 to 0.016.

FIG. 13 presents a computer result of said Model, wherein T₀=400 K, the moles of H₂O range from 0.021 to 0.063 and the moles of H₂ range from 0.005 to 0.016.

FIG. 14 presents a computer result of said Model, wherein T₀=300 K, the moles of H₂O range from 0.028 to 0.084 and the moles of H₂ range from 0.010 to 0.050.

FIG. 15 presents a computer result of said Model, wherein T₀=300 K, the moles of H₂O range from 0.028 to 0.084 and the moles of H₂ range from 0.060 to 0.100.

FIG. 16 presents a computer result of said Model, wherein T₀=300 K, the moles of H₂O range from 0.000 to 0.020 and the moles of H₂ range from 0.060 to 0.10.

FIG. 17 presents a computes result of said Model, wherein T₀=300 K, the moles of H₂O range from 0.100 to 0.0200 and the moles of H₂ range from 0.060 to 0.010.

FIG. 18 presents a flow diagram of the instant invention operating in the configuration of an internal combustion engine. Within FIG. 18 it is to be understood that the make-up H₂ may come from either an H₂ source or from H₂ storage. It is preferred that said storage be preferably a cryogenic storage. It is preferred that said cryogenic storage is maintained with at least one selected from a list consisting of liquefaction of said H₂, chilling of said H₂ with cryogenic N₂, insulation of said H₂ storage, and any combination therein. Within FIG. 18 it is to be understood that said make-up O₂ is at least one of enriched, pure and very pure O₂, and wherein said O₂ is obtained from at least one of cryogenic distillation of air, membrane separation of air, pressure swing adsorption of air, vacuum swing adsorption of air, and any combination therein. Within FIG. 18 it is preferred that said cryogenic N₂ is obtained from said cryogenic distillation of air. Within FIG. 18 it is an embodiment that said make-up O₂ be air. Within FIG. 18 is depicted two exhaust valves from each of said combustion chamber(s); it is to be understood that it is preferred to operate the instant invention wherein each combustion chamber exhaust sends steam to a steam turbine, wherein said steam turbine turns at least one of a generator and an alternator, wherein the electricity created by said generator and/or said alternator is sent to an electrolysis unit, wherein the H₂O in said electrolysis unit comprise condensate from the combustion of H₂ and O₂ in said combustion chamber, wherein said electrolysis unit converts said H₂O into H₂ and O₂ for use in said combustion chamber. Within FIG. 18 is depicted two exhaust valves from said combustion chamber(s); it is to be understood that it is preferred to operate the instant invention wherein the combustion chamber exhaust sends steam to a condenser, wherein the H₂O from said condenser is at least partially used in said combustion chamber. Within FIG. 18 is depicted two exhaust valves from said combustion chamber(s); it is to be understood that it is most preferred to operate the instant invention wherein the combustion chamber at least partially sends steam to a steam turbine, wherein said steam turbine turns at least one of a generator and an alternator, wherein the electricity created by said generator and/or said alternator is sent to an electrolysis unit, wherein the H₂O in said electrolysis unit comprises condensate from the combustion of H₂ and O₂ in said combustion chamber, wherein said electrolysis unit converts said condensate into H₂ and O₂ for use in said combustion chamber, and wherein steam is at least partially sent to a condenser, wherein the H₂O from said condenser is used in said combustion chamber.

FIG. 19 presents a flow diagram of the instant invention operating in the configuration of a steam turbine electrical power plant.

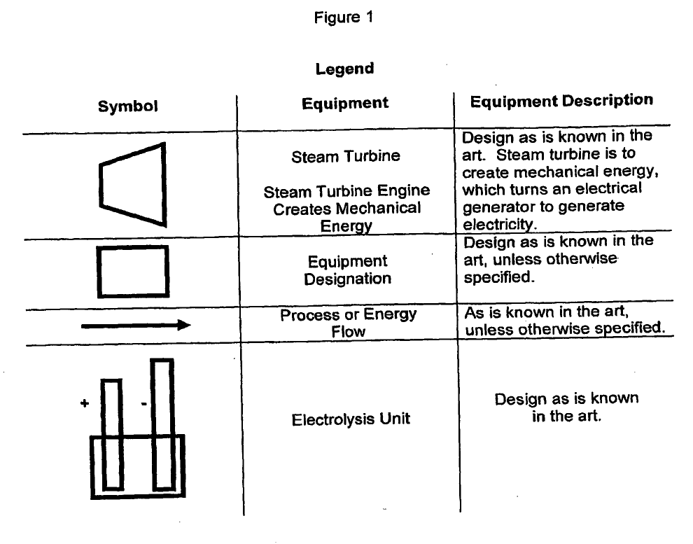

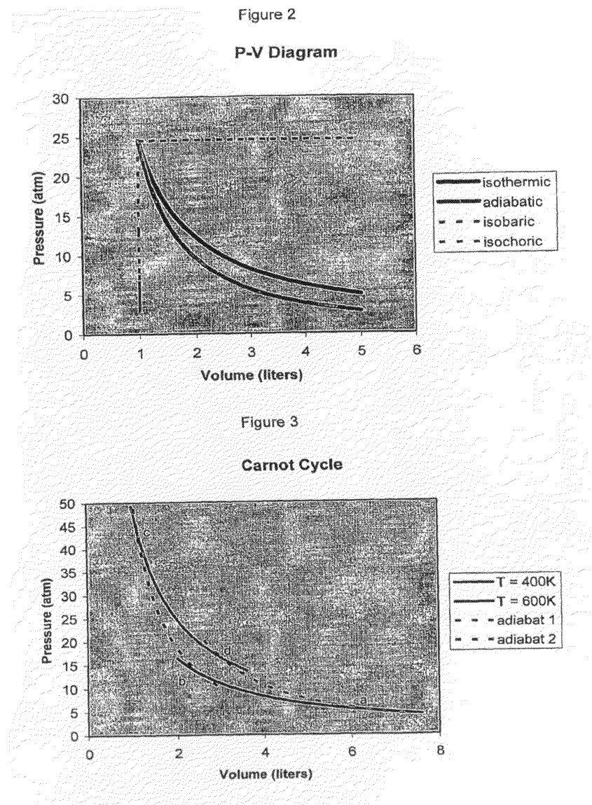

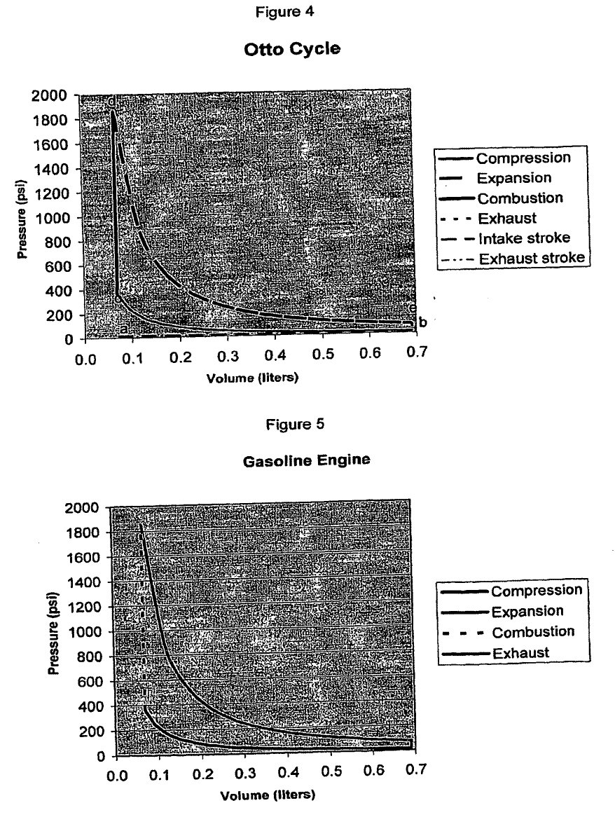

### DETAILED DESCRIPTION OF THE PREFERRED EMBODIMENTS

The timing of the WCT Instant Invention is significant since global warming is becoming a global political issue. The timing of the WCT Instant Invention is significant since the availability of oil and natural gas, sources of hydrocarbons for hydrocarbon combustion, are becoming global political issues. The timing of the WCT Instant Invention is significant since the market of natural gas (methane, ethane, propane and/or butane) is affecting the production and/or market price of electricity. The timing of the WCT Instant Invention is significant since air pollution is becoming a health issue for much of humanity, as well as a weather issue due to global warming. The discovered WCT Instant Invention presents environmentally friendly combustion methods, processes, systems and apparatus, which are efficient and which will require a reasonable amount of tooling to implement. And, in the case of transportation, the WCT Instant Invention presents a combustion process, which will have a “feel” to the driver which is similar to that of hydrocarbon combustion engines; this “fed” will further acceptance of the instant invention.

The WCT Instant Invention utilizes the combustion of H₂ with O₂ to create energy. It is preferred that the methods, process, systems and apparatus of the WCT Instant Invention produce at least one selected from a list consisting of: rotating mechanical energy, power, torque and any combination therein. The WCT Instant Invention utilizes H₂O to cool the engine by adding H₂O to the combustion chamber, while utilizing the steam (hot gaseous H₂O) produced during combustion and/or during cooling as a means of energy recycle and/or energy conservation by converting at least a portion of said steam energy into potential energy (fuel) for the instant invention. The combustion chamber is defined herein as a volume wherein combustion takes place or wherein the products of combustion create at least one of energy, power, torque and any combination therein. Said recycled potential energy is to be at least one of O₂ and H₂.

It is a preferred embodiment that combustion is at least one of: internal combustion, open flame (heating) combustion and turbine combustion, as these applications are known in the art of combustion science.

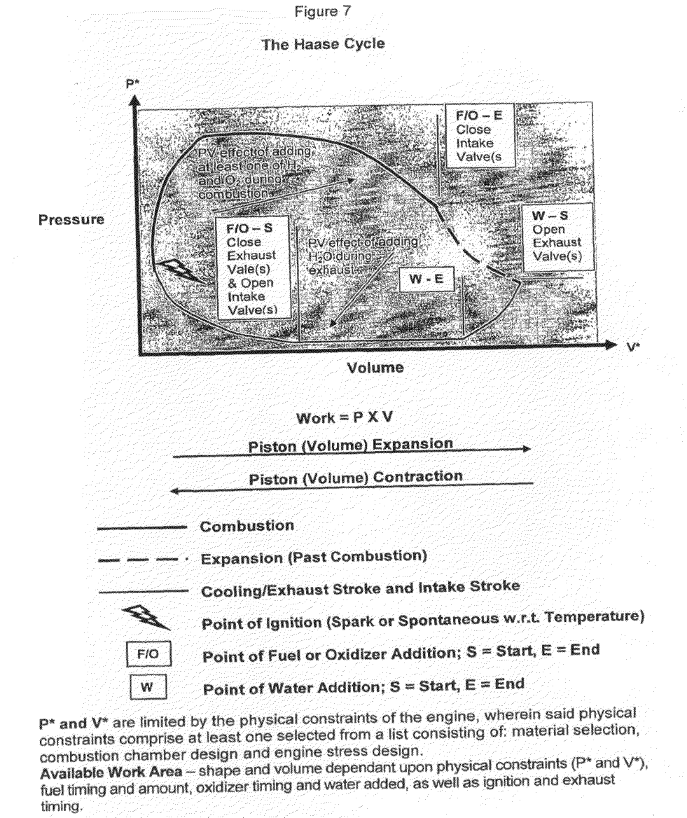

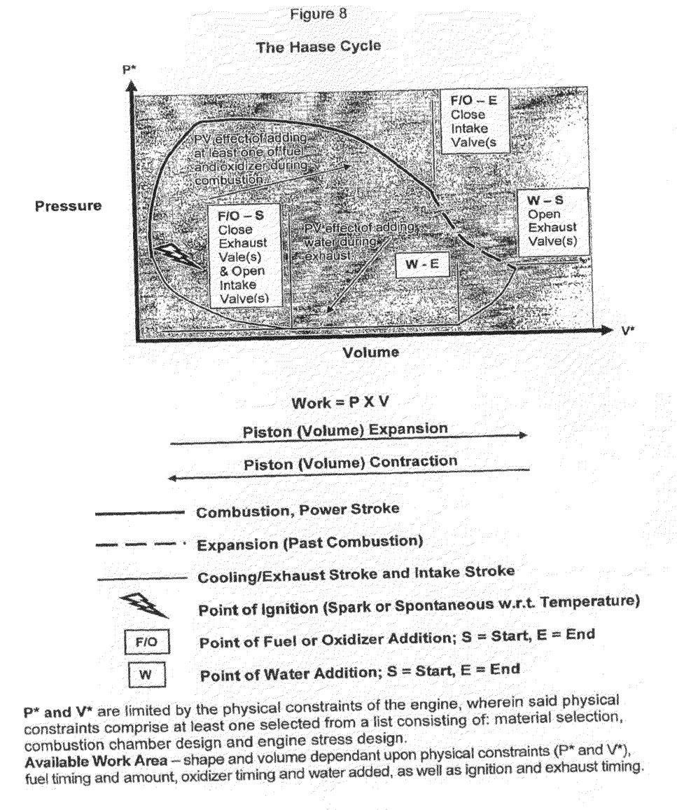

The Haase Cycle (Depicted in FIGS. 7 and 8)—It is most preferred that the WCT Instant Invention combust as a fuel H₂ with at least one of enriched O₂, pure O₂ and very pure O₂ as the oxidant. It is a preferred embodiment that at least one of said enriched O₂, pure O₂ and very pure O₂ is augmented with air. It is an embodiment that said WCT engine combust H₂ with air, wherein said air is in excess over that required to perform combustion, and wherein said excess air reduces the formation of NOₓ from combustion. It is most preferred that said excess air combustion be an H₂/air ratio of about 40% to about 80%. It is preferred that said excess air be an H₂/air ratio of greater than about 20%.

It is preferred that the WCT Instant Invention be insulated to minimize enthalpy losses from the engine block. It is most preferred that the combustion chamber be insulated. It is most preferred that each combustion chamber be insulated, wherein there is at least one combustion chamber. It is preferred that the WCT Instant Invention operate wherein H₂O is added to the combustion chamber in order to cool and/or manage the temperature of the WCT Instant Invention. It is most preferred that the WCT Instant Invention operate wherein H₂O is added to the combustion chamber during at least one of the expansion cycle and the exhaust cycle (or at a point in the expansion or exhaust portion of combustion in the case of a turbine) in order to cool and/or manage the temperature of said WCT Instant Invention. It is most preferred that said H₂O addition to combustion allow for a reduction in combustion temperature to a temperature lower than that which would be obtained without the addition of H₂O to combustion exhaust. It is most preferred that said H₂O addition to combustion expand at least one of: the P-V relationship, work, power, energy, torque and any combination therein available from said WCT Instant Invention.

It has been learned in the WCT Instant Invention that at least one selected from a list consisting of reducing operating pressure, expanding P-V relationship, increasing available work, increasing available power, increasing available energy and any combination therein, can be performed by operating the WCT in a Newsom burn. It is most preferred to operate the WCT Instant Invention, wherein at least one of the H₂ and the O₂ is added during the generation of power (in the case of an internal combustion engine this would be defined as the power stroke). Further, due to the auto-ignition temperature of H₂, which is approximately 585° C., it is most preferred to operate the WCT Instant Invention without a spark or ignition device; such operation is defined herein defined as “diesel-like fashion.”

It is preferred to operate the WCT Instant Invention with the addition of H₂O to the combustion chamber during exhaust and to operate in diesel like fashion. It is most preferred to operate the WCT Instant Invention with the addition of H₂O to the combustion chamber during exhaust and to operate in diesel fashion. It is most preferred to operate the WCT Instant Invention in the configuration of an internal combustion engine, as is known in the art, wherein the WCT Instant Invention operate with 2 cycles, as depicted in FIG. 7. It is preferred to operate WCT Instant Invention in the configuration of an internal combustion engine, as is known in the art, wherein the number of cycles is 4, as depicted in FIG. 8.

It is most preferred that operation of the WCT Instant Invention be in either diesel like fashion or in diesel fashion with a slow burn situation by the addition of at least one of H₂ and O₂, thereby creating a Newsom burn. It is most preferred to operate the instant invention wherein at least one of H₂ and O₂ is added to the combustion chamber at a pressure of greater than about 1.0 atmosphere.

Energy Recovery Cooling—It is an embodiment to perform cooling of the combustion chamber of the WCT Instant Invention wherein H₂O in the form of at least one of a liquid and a gas is added to the combustion chamber at a time before or after combustion. In the case of a turbine, as a turbine spins within a housing comprising 360° and the flame of the combustion chamber is located within at least one point of said 360° of said combustion housing, said H₂O is preferably to be added to at least one additional point of said 360° of said combustion housing and in such an amount that said H₂O cannot extinguish combustion flame. In the case of an internal combustion engine, it is preferred that said H₂O be added to the combustion chamber during a cycle in which combustion does not occur, thereby cooling said combustion chamber with said H₂O. (A cycle is herein defined as movement of the piston from top dead center (TDC) to full available piston displacement within the combustion cylinder and returning to TDC.) It is preferred to add said H₂O to the combustion chamber in an internal combustion engine during a cycle in which combustion does not occur as the addition of said H₂O during any portion of a cycle after combustion occurs may have a negative impact on engine power due to the relationship of the latent heat of vaporization of H₂O as compared to the specific heat of H₂O as a gas (steam); the latent heat of vaporization of H₂O is about 41 kJ/mole, as compared to the heat capacity of steam which is only about 34 J/(mole ° K.).

It is preferred that H₂O added to the combustion cylinder of an internal combustion engine be added as near the beginning of the cycle (TDC) as is practical. As is revealed in the instant invention in examples 10 to 23, the available work from steam and the available cooling from adiabatic expansion of steam is directly related to the amount of adiabatic expansion of said steam in combination with the beginning temperature of said steam and the amount of said steam. It is preferred that there be at least one cycle in which H₂O is added to the combustion chamber of an internal combustion engine. The number of cycles adding H₂O to the combustion chamber of an internal combustion engine prior to the next combustion cycle is limited by the available enthalpy (measured as temperature) in the combustion chamber from the previous combustion cycle and the cooling affect of steam during adiabatic expansion of said steam. Depending on the beginning temperature, the amount of H₂O converted to steam and the amount of adiabatic expansion, it is an embodiment that there a number of cycles of Energy Recovery Cooling, wherein said number can be from 1 to 20. It is preferred that H₂O is added to the combustion chamber during at least one cycle or operating time wherein combustion is not performed and the H₂O absorbs enthalpy from the combustion chamber, thereby creating steam energy and cooling the combustion chamber; and

It is an embodiment that the materials of construction of the combustion chamber have a high heat transfer coefficient, such as that which is available with metals. Energy Recovery Cooling is most effective when the energy contained within the combustion chamber is easily transferred to the H₂O, thereby creating steam energy. It is an embodiment that the materials of construction of the combustion chamber have a high heat capacity, such as that which is available with metals. As the combustion chamber of the internal combustion engine is inherently inefficient loosing near 50 to 80 percent of the energy of combustion to heat and exhaust gases, Energy Recovery Cooling can most effectively improve engine power and efficiency when combustion heat energy, enthalpy, from the previous combustion cycle is stored within the material(s) of construction of the combustion chamber.

Engine Efficiency—The instant invention utilizes electro-chemical pathways to convert H₂O into O₂ and H₂, wherein the electrical energy for these pathways is obtained from at least one of: cooling the engine, exhaust gas energy, combustion output mechanical energy, photovoltaic energy and the energy of air or H₂O motion. Given that the efficiency of most combustion engines (especially the internal combustion engine) is only approximately 15 to 25 percent (near 20 percent), the instant invention can significantly increase engine efficiency.

It is discovered that the theoretical limit of efficiency for the discovered WCT is approximately limited to the available enthalpy recovery during Energy Recovery Cooling in combination with the efficiency limit in the conversion of steam, mechanical, photovoltaic, wind and moving H₂O energy to electricity in combination with the efficiency limit of electrolysis to convert H₂O into H₂ and O₂ minus friction losses. This theoretical limit presents that the theoretical efficiency limit of the WCT Instant Invention to be near approximately 60-90 percent. (There is an interesting situation, wherein the engine is not running and a photovoltaic cell, wind and/or moving H₂O energy increases the potential energy by creating fuel from H₂O. Under this scenario the engine actually increases its fuel without using any fuel, wherein the efficiency is infinite.

O₂—The instant invention presents WCT Instant Invention means for separating air into at least one of enriched, pure and very pure O₂ (herein all are termed 0), along with N₂ in combination with the combustion of said O₂. By the first method, preferred, air is separated utilizing the cryogenic distillation process, which is used to pressure, chill and distill the air. By the second method, air is separated utilizing membranes, wherein said membranes can be of organic polymer construction or of inorganic construction. By the third method, air is separated by utilizing SA. It is an embodiment that said O₂ comprise at least one of N₂ and Ar.
Cryogenic Distillation—In the chemical industry, cryogenic distillation of air into O₂ and N₂ is a common pathway to produce these elemental diatomic gases. However, it has not been proposed previously and it is a preferred embodiment to utilize this process: in combination with H₂ distillation, to fuel the combustion of O₂ with H₂, and to utilize the energy of the combustion of O₂ with H₂ to power the cryogenic distillation of air. In addition, nearly all industrial processes for the separation of air into O₂ and N₂ utilize N₂ or N₂ and Ar₂ as industrial products. In the case of the discovered WCT Instant Invention, the primary use of distilled N₂ and/or Ar would be as a heat sink. This heat sink is preferably utilized to perform at least one selected from a list consisting of: cool the storage of O₂, cool the storage of H₂, facilitate the process of cryogenic distillation, cool the WCT combustion engine, provide refrigeration, provide environmental cooling, provide an energy source to turn a turbine generating electricity and any combination therein. In the case of the internal combustion engine, this heat sink is preferably used at least partially in place of the engine H₂O coolant cooling system (typically a fan cooled radiator). A preferred use of said distilled N₂ and/or Ar would be to allow said N₂ and/or Ar to warm and thereby expand so as to be available as an energy source to drive a turbine to generate electricity and/or to create mechanical energy. Further, the distillation of Ar from N₂ is immaterial except as a combustion efficiency improvement; the additional fractionating column to separate Ar and/or N₂ from O₂ should be viewed on a capital investment—efficiency rate of return analysis.

It is preferred to power a cryogenic air separation system with at least one of rotational mechanical energy and electricity. It is preferred that at least a portion of said rotational mechanical energy and/or electricity be generated by the WCT Instant Invention. It is preferred that at least a portion of said rotational mechanical energy or electricity be generated by the WCT Instant Invention, wherein combustion is cooled by the addition of H₂O to the combustion chamber. It is preferred that at least a portion of said rotational mechanical energy or electricity be generated by the WCT Instant Invention, wherein said air is in excess over that required to perform combustion to limit NOₓ formation. It is preferred that said cryogenic distillation separate H₂.

Cryogenic Storage of H₂ and/or O₂—It is a preferred embodiment to store at least one of O₂ and H₂ at a temperature of less than 0° C., herein referred to as cryogenic O₂ and cryogenic H₂, respectively. It is a preferred embodiment to utilize cryogenically available N₂ or Ar to cool said O₂ and/or said H₂ to a temperature of less than 0° C. It is a preferred embodiment to utilize cryogenically available N₂ or Ar to cool said H₂ to a temperature at which said H₂ has a positive JtC. It is a most preferred embodiment to utilize cryogenically available N₂ or Ar to cool said H₂ to a temperature at which said H₂ has a positive JtC, wherein said H₂ is cooled by a refrigeration loop utilizing at least one of H₂, N₂ and Ar as the refrigerant. It is preferred that said refrigeration loop be powered by at least one of: the WCT Instant Invention, expansion of cryogenically available N₂ or Ar, and an outside source of electricity. It is a most preferred embodiment to utilize cryogenically available N₂ or Ar to cool said H₂ to a temperature at which said H₂ has a positive JtC, wherein said H₂ is cooled by a refrigeration loop utilizing at least one of H₂, N₂ and Ar₂ as the refrigerant, and wherein said H₂ is stored at a temperature of about less than 200° R.
Gel—It is preferred to improve the handling of H₂ by creating a H₂ gel. Said H₂ gel is to be formed by the inclusion of at least one selected from a list consisting of: H₂O, O₂ and methane in said H₂, wherein said H₂ is in a cryogenic state such that said inclusion is in a frozen crystalline state, thereby causing said H₂ and inclusion to form and behave as a gel. It is preferred to improve the handling of O₂ by creating an O₂ gel. Said O₂ gel is to be formed by the inclusion of at least one selected from a list consisting of: H₂O, and methane in said O₂, wherein said O₂ is in a cryogenic state such that said inclusion is in a frozen crystalline state, thereby causing said O₂ and inclusion to behave as a gel.
Cooling—It is preferred that the heat sink products from the cryogenic distillation of air be used to cool at least one of a gas and a liquid. It is most preferred that at least one of the available N₂, O₂ and Ar from cryogenic distillation be used to cool at least one of a gas and a liquid. It is most preferred that said gas is air and that said liquid is H₂O.
Membrane Separation—Membrane separation is a preferred method of obtaining at least one of enriched, pure and very pure O₂. It is most preferred that said membrane separation be performed wherein there is an electrical current provided across the membrane to assist in the separation of air into at least one of enriched, pure and very pure O₂.
SA—At least one of PSA and VSA separation of air is a preferred embodiment to obtain at least one of enriched, pure and very pure O₂ for the WCT Instant Invention. PSA and VSA (SA) have the same drawback as membrane separation, as compared to cryogenic distillation of air; as N₂ is not be available as a heat sink, wherein it is from cryogenic distillation of air.
Insulation—It is preferred to insulate the WCT Instant Invention. It is preferred to insulate the WCT Instant Invention, wherein said engine is cooled by the addition of H₂O to the combustion cylinder. It is preferred to insulate the WCT Instant Invention, wherein said air is in excess over that required to perform combustion so as to limit NOₓ formation.

It is most preferred that said insulation be that as is known in the art. It is preferred that said insulation be located around each combustion chamber to thereby minimize the use of high temperature materials in construction of the WCT Instant Invention. In the case of an ICE, it is preferred that each combustion chamber (most likely of cylinder type design) be insulated with insulation materials as known in the art of insulation. In the case of an ICE, it is preferred that each combustion chamber (most likely of cylinder type design) be insulated with insulation materials as known in the art of insulation, wherein said insulation materials slow the rate of heat transfer from said combustion chamber via a shape of insulation material which is cylindrical and which surrounds said combustion chamber. In the case of an ICE, it is preferred that each combustion chamber (most likely of cylinder type design) be insulated with insulation materials as known in the art of insulation, wherein the piston contains a layer of insulation to reduce the rate of heat transfer from the combustion chamber into the block of the engine. In the case of an ICE, it is preferred that each combustion chamber (most likely of cylinder type design) be insulated with insulation materials as known in the art of insulation, wherein the head components of said ICE comprise a layer of insulation to reduce the rate of heat transfer from the combustion chamber to said head components or to the surrounding environment. In the case of an ICE, it is preferred that each combustion chamber (most likely of cylinder type design) be insulated with insulation materials as known in the art of insulation, wherein said ICE is cool to the touch. In the case of an ICE, it is preferred that each combustion chamber (most likely of cylinder type design) be insulated with insulation materials as are known in the art of insulation, wherein said ICE is cool to the touch, wherein the surface temperature of said ICE is at least about less than 150° F. In the case of a turbine, it is preferred that each combustion chamber (most likely of cylinder type design) be insulated with insulation materials as are known in the art of insulation.

It is preferred that ceramic materials are used. A ceramic material is herein defined as a compound comprising at least one metal, other than iron, which forms a crystalline structure, wherein said crystalline structure is formed by heat.

Steam Conversion—It is preferred to convert WCT exhaust gas H₂O, steam, into H₂ utilizing corrosion to chemically convert the steam to H₂. Said corrosion is to utilize the O₂ in the steam to convert at least one metal to its metal oxide, while releasing H₂. It is most preferred to produce an electromotive potential in at least one metal to drive the corrosion process for the at least one metal to its metal oxide, while producing H₂. It is most preferred that said electromotive potential be anodic.
Electrolysis—It is preferred to electro-chemically convert exhaust gas H₂O into O₂ and H₂. It is to be understood that under the best of engineered circumstances, the electrical energy required by electrolysis to convert H₂O into O₂ and H₂ will be greater than the energy obtained by the combustion of O₂ and H₂. However, electrolysis allows for significant improvements in the thermodynamic efficiency of combustion by reclaiming energy which would otherwise be lost.

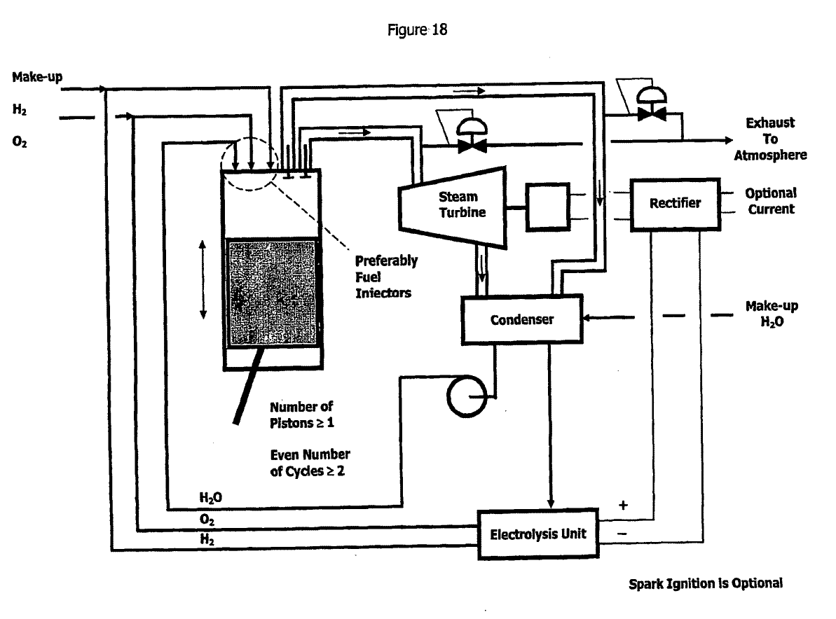

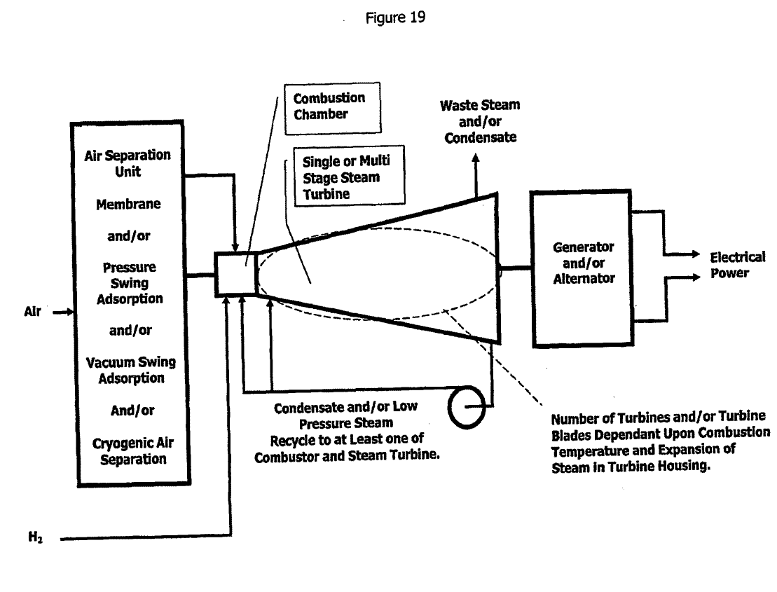

As the installation of a steam turbine in the engine exhaust will create a back pressure situation to the engine, thereby lessening engine power and efficiency, it is preferred that the instant invention include at least two combustion chamber exhaust gas channels or piping as depicted in FIG. 18, such that at least a portion of the steam created in the combustion chamber is sent to said steam turbine and at least a portion of said steam created in the combustion chamber is sent to a condenser, thereby evacuating the combustion chamber and minimizing combustion chamber pressure prior to the next combustion cycle. It is most preferred that the condenser for steam exiting the steam turbine and the condenser for the steam evacuating the combustion chamber be the same condenser. It is an embodiment that the condenser for steam exiting the steam turbine be separate from the condenser for the steam evacuating the combustion chamber. It is preferred that make-up H₂O to the instant invention be added to at least one of said condenser(s). It is preferred that the H₂O added to the combustion chamber comprise H₂O from said condenser(s). It is preferred that at least a portion of the H₂O in said condenser(s) be transferred to an electrolysis unit. It is preferred that the H₂O in said electrolysis unit be converted to H₂ and O₂ by electrolysis. It is preferred that at least a portion of said H₂ be used as a fuel in said combustion chamber. It is preferred that at least a portion of said O₂ be used as an oxidizer in said combustion chamber. It is most preferred that the electrical energy of said electrolysis unit be obtained from at least one of an alternator and a generator wherein the power to turn said at least one of an alternator and a generator be obtained from at least one selected from a list consisting of: a steam turbine turned by the exhaust gases (steam) from the combustion chamber(s), a drive shaft turned by the combustion chambers, moving wind energy, moving H₂O energy, and any combination therein.

Electrolysis Electrical Energy—It is preferred to obtain the electrical energy for electrolysis from at least one method selected from a list consisting of: rotating mechanical energy turning a generator, exhaust gas steam energy turning turbine which turns a generator, light energy via a photovoltaic cell, wind energy (moving air) turning a turbine which turns an electrical generator, H₂O energy (moving H₂O) turning a turbine which turns a generator and any combination therein. It is most preferred that said rotating mechanical energy comprise rotating mechanical energy created by an engine using H₂ as a fuel and at least one of enriched O₂, pure O₂ and very pure O₂ as an oxidizer. It is most preferred that said rotating mechanical energy comprise rotating mechanical energy created by an engine using H₂ as a fuel and at least one of enriched O₂, pure O₂ and very pure O₂ as an oxidizer, wherein said engine is cooled by the addition of H₂O to the combustion chamber. It is most preferred that said rotating mechanical energy comprise rotating mechanical energy created by an engine using H₂ as a fuel with air as the oxidizer, wherein said air is in excess over that required to perform combustion to limit NOₓ formation.
Potential Energy/Fuel Generation—It is most preferred that at least a portion of the H₂ and/or O₂ from the electrolysis of H₂O be used in an engine Icing H₂ as a fuel and at least one of enriched O₂, pure O₂ and very pure O₂ as an oxidizer. It is most preferred that at least a portion of the H₂ and/or O₂ from the electrolysis of H₂O be used in an engine using H₂ as a fuel and at least one of enriched O₂, pure O₂ and very pure O₂ as an oxidizer, wherein said engine is cooled by the addition of H₂O to the combustion chamber. It is most preferred that at least a portion of the H₂ and/or O₂ from the electrolysis of H₂O be used in an engine using H₂ as a fuel with air as the oxidizer, wherein said air is in excess over that required to perform combustion to limit NOₓ formation.
Electricity Generation—It is preferred to generate electrical energy, wherein said electrical energy (electricity) is created from a generator, wherein said generator is turned by rotating mechanical energy, wherein said rotating mechanical energy is created by an engine using H₂ as a fuel and at least one of enriched O₂, pure O₂ and very pure O₂ as an oxidizer. It is preferred to generate electricity, wherein said electricity is created from a generator, wherein said generator is turned by rotating mechanical energy, wherein said rotating mechanical energy is created by an engine using H₂ as a fuel and at least one of enriched O₂, pure O₂ and very pure O₂ as an oxidizer, wherein said engine is cooled by the addition of H₂O to the combustion chamber. It is preferred to generate electricity, wherein said electricity is created from a generator, wherein said generator is turned by an engine using H₂ as a fuel with air as the oxidizer, wherein said air is in excess over that required to perform combustion to limit NOₓ formation.

It is a preferred embodiment that said rotating mechanical rotating energy enter a transmission, wherein said transmission engage in a manner that is inversely proportional to the torque and/or work load of the engine, wherein said transmission output mechanical rotating energy turn said generator to create said electrical energy. Said transmission is to be as is known in the art. It is most preferred that said transmission engage a flywheel capable of storing rotational kinetic energy, wherein said flywheel turns said generator.

It is preferred to generate electricity, wherein said electricity is created from a generator, wherein said generator is turned by a steam turbine, wherein said steam turbine is turned by steam, wherein said steam is created by an engine using H₂ as a fuel and at least one of enriched O₂, pure O₂ and very pure O₂ as an oxidizer. It is preferred to generate electricity, wherein said electricity is created from a generator, wherein said generator is turned by a steam turbine, wherein said steam turbine is turned by steam, wherein said steam is created by an engine using H₂ as a fuel and at least one of enriched O₂, pure O₂ and very pure O₂ as an oxidizer, wherein said engine is cooled by the addition of H₂O to the combustion chamber. It is preferred to generate electricity, wherein said electricity is created from a generator, wherein said generator is turned by a steam turbine, wherein said steam turbine is turned by steam, wherein said steam is created by an engine using H₂ as a fuel with air as the oxidizer, wherein said air is in excess over that required to perform combustion to limit NOₓ formation. It is preferred that said steam turbine(s) be in such a configuration that said steam be the exhaust of said engine. It is preferred that said steam energy be converted into rotational mechanical energy via a turbine to turn said generator. It is most preferred that there be at least one steam turbine and that said steam turbine(s) create mechanical energy to turn at least one of said generator(s).

It is preferred to generate electricity by the energy of light using photovoltaic cells, wherein said electricity is used to electrochemically convert H₂O into H₂ and O₂, and wherein at least one of said H₂ and O₂ is used in the combustion chamber of the WCT Instant Invention.

It is preferred to generate electricity by the energy of moving air or H₂O, wherein said moving air energy turns a generator to create electricity, wherein said electricity is used to electrochemically convert H₂O into H₂ and O₂, and wherein at least one of said H₂ and O₂ is used in the combustion chamber of the WCT Instant Invention.

It is preferred to generate electricity by the energy of moving H₂O, wherein said moving H₂O energy turns a generator to create electricity, wherein said electricity is used to electrochemically convert H₂O into H₂ and O₂, and wherein at least one of said H₂ and O₂ is used in the combustion chamber of the WCT Instant Invention.

It is preferred to generate electricity by nuclear means, wherein said nuclear means is defined herein as the generation of heat energy generated from the radioactive decay of at least one element or the generation of He from H₂, wherein said heat energy is used to create steam energy, wherein said steam energy is used to turn at least one steam turbine, and wherein said steam turbine turns at least one generator to create said electricity. It is preferred that said electricity is used to electrochemically convert H₂O into H₂ and O₂, wherein at least one of said H₂ and O₂ is used in the combustion chamber of the WCT Instant Invention.

It is preferred to generate electricity, wherein said electricity is generated by at least one selected from a list consisting of photovoltaic cells, moving air, moving H₂O, nuclear means and any combination therein, wherein said electricity is at least partially utilized in an electrolysis unit to convert H₂O to H₂ and O₂, and wherein at least a portion of at least one of said H₂ and O₂ is used in the combustion chamber of the WCT Instant Invention.

H₂O Chemistry—H₂O is the most efficient and economical method of storing O₂ and/or H₂. Electrolysis is the most preferred method of converting H₂O into combustible H₂ and O₂. Electrolysis is best performed with a dissolved electrolyte in the H₂O; the dissolved electrolyte, most preferably a salt, will improve conductivity in the H₂O, thereby reducing the required electrical energy to perform electrolysis. It is an embodiment to perform electrolysis upon H₂O that contains an electrolyte. It is preferred to perform electrolysis upon H₂O that contains a salt. It is most preferred to perform electrolysis upon H₂O that contains polyelectrolytes.

However, many dissolved cation(s) and anion(s) combination(s) can precipitate over time reducing the efficiency of electrolysis. Further, as temperature is increased, hard H₂O contaminants may precipitate; therefore, it is preferred to add a dispersant to the H₂O to prevent scale.

Dispersants are low molecular weight polymers, usually organic acids having a molecular weight of less than 25,000 and preferably less than 10,000. Dispersants are normally polyelectrolytes. Dispersant chemistry is based upon carboxylic chemistry, as well as alkyl sulfate, alkyl sulfite and alkyl sulfide chemistry; it is the O₂ atom that creates the dispersion, wherein O₂ takes its form in the molecule as a carboxylic moiety and/or a sulfoxy moiety. Dispersants that can be used in the WCT Instant Invention which contain the carboxyl moiety comprise at least one selected from a list consisting of: acrylic polymers, acrylic acid, polymers of acrylic acid, methacrylic acid, maleic acid, fumaric acid, itaconic acid, crotonic acid, cinnamic acid, vinyl benzoic acid, any polymers of these acids and any combination therein. Dispersants that can be used in the WCT Instant Invention contain the alkyl sulfoxy or allyl sulfoxy moieties include any alkyl or allyl compound, comprise at least one selected from a list consisting of: SO, SO₂, SO₃ and any combination therein. Due to the many ways in which an organic molecule can be designed to contain the carboxyl moiety and/or the sulfoxy moiety, it is an embodiment that any H₂O soluble organic compound containing at least one of a carboxylic moiety and/or a sulfoxy moiety may be added to the H₂O in the WCT Instant Invention. (This is with the knowledge that not all dispersants have equivalent dispersing properties. Acrylic polymers exhibit very good dispersion properties, thereby limiting the deposition of H₂O soluble salts and are most preferred embodiments as a dispersant. The limitation in the use of a dispersant is in the H₂O solubility of the dispersant in combination with its carboxylic nature and/or sulfoxy nature.)

H₂O is inherently corrosive to metals. H₂O naturally oxidizes metals, some with a greater oxidation rate than others. To minimize corrosion, it is preferred that the have a pH of equal to or greater than 7.5, wherein the alkalinity of the pH is obtained from the hydroxyl anion. Further, to prevent corrosion or deposition of H₂O deposits on steam turbines, it is preferred to add a corrosion inhibitor to the H₂O. It is an embodiment to utilize N₂ containing corrosion inhibitors, such as hydrazine, as is known in the art of H₂O treatment.

While corrosion inhibitors are added to H₂O to prevent corrosion, a chelant is preferred to both prevent corrosion and complex, as well as prevent the deposition of a cation, including hardness and heavy metals. A chelant or a chelating agent is a compound having or forming a heterocyclic ring wherein at least two kinds of atoms are joined in a ring. Chelating is forming a heterocyclic ring compound by joining a chelating agent to a metal ion. Most chelants are polyelectrolytes. It is a preferred embodiment to use a chelant in the H₂O and or the steam to control mineral deposition. It is preferred to add to the H₂O and/or the steam at least one selected from a list consisting of a: phosphate, phosphate polymer, phosphate monomer and any combination thereof. Said phosphate polymers consist of, but are not limited to, phosphoric acid esters, metaphosphates, hexametaphosphates, pyrophosphates and/or any combination thereof. Phosphate polymers are particularly effective in dispersing magnesium silicate, magnesium hydroxide and calcium phosphates. Phosphate polymers are particularly effective at corrosion control. With proper selection of a polymer, along with maintaining an adequate polymer concentration level, the surface charge on particle(s) can be favorably altered. In addition to changing the surface charge, polymers also function by distorting crystal growth.

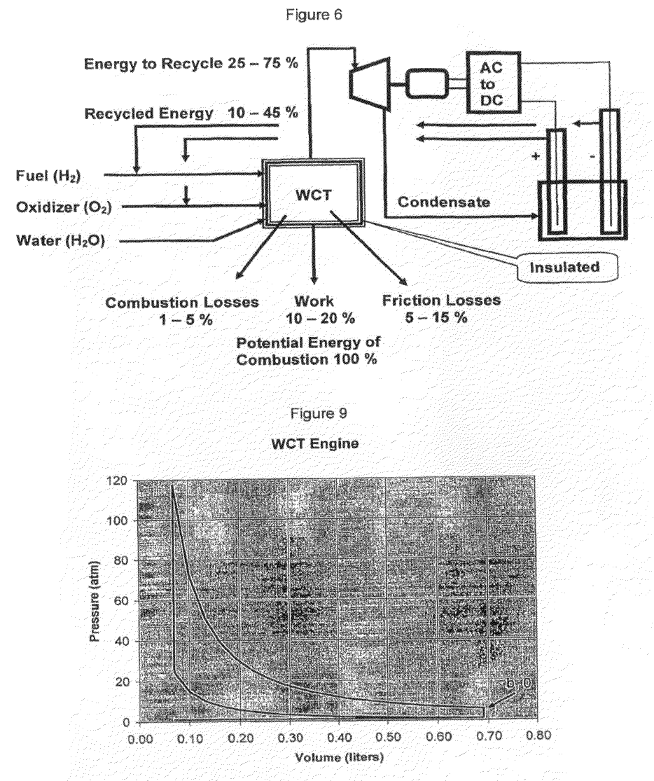

Operating Pressure Management—An engine recycling exhaust gas energy has the potential to develop unintended operating situations, wherein the operating pressure becomes greater than the design pressure of the equipment employed; any such situation can be a significant safety issue. And, regardless of a safety situation, the recycling of exhaust gas energy from an engine which may operate in a situation of changing exhaust gas conditions, comprises a situation wherein the pressure of said exhaust gas should be managed in order to protect equipment and manage equipment operation. Operating pressure management is to include a pressure management device, herein termed a pressure control device, which may include any type of pressure controller and/or pressure relief device as is known in the art of managing gas pressure. Such devices can include, yet are not limited to: a pressure control valve, a pressure control loop including a valve, a relief valve, a rupture disc and any combination therein. It is an embodiment to provide a pressure control device to an engine using H₂ as a fuel and at least one of enriched O₂, pure O₂ and very pure O₂ as an oxidizer. It is an embodiment to provide a pressure control device to an engine using H₂ as a fuel and at least one of enriched O₂, pure O₂ and very pure O₂ as an oxidizer, wherein said engine is cooled by the addition of H₂O to the combustion chamber. It is an embodiment to provide a pressure control device to an engine using H₂ as a fuel with air as the oxidizer, wherein said air is in excess over that required to perform combustion to limit NOₓ formation. It is a preferred embodiment to provide a pressure control device to an engine using H₂ as a fuel and at least one of enriched O₂, pure O₂ and very pure O₂ as an oxidizer, wherein the exhaust gas of said engine comprises steam, and wherein said steam turns a steam turbine. It is a preferred embodiment to provide a pressure control device to art engine using H₂ as a fuel and at least one of enriched O₂, pure O₂ and very pure O₂ as an oxidizer, wherein said engine is cooled by the addition of H₂O to the combustion chamber, wherein the exhaust gas of said engine comprises steam, and wherein said steam turns a steam turbine. It is a preferred embodiment to provide a pressure control device to an engine using H₂ as a fuel with air as the oxidizer, wherein said air is in excess over that required to perform combustion to limit NOₓ formation, wherein the exhaust gas of said engine comprises steam, and wherein said steam turns a steam turbine.
Apparatus—Referring to FIG. 6, a WCT combustion engine is symbolically shown for receiving as fuel H₂ and as an oxidizer O₂, wherein said O₂ is at least one of enriched, pure and very pure O₂ and herein defined as O₂ source. It is presented that said O₂ can be at least partially replaced with air, wherein said air is in excess to limit NOₓ formation by limiting combustion temperature. Said combustion engine may be of any type, wherein combustion is performed to generate at least one of mechanical torque, heat, thrust, electricity and/or any combination therein. It is preferred that H₂ be received in the combustion chamber, along with said fuel, such that said H₂ to the combustion chamber is to have a flow. O₂ flowing to the combustion chamber is to have a flow. Air flowing to the combustion chamber is to have a flow. There is to be means to measure said H₂ flow, means to measure said O₂ flow and means to measure said air flow, such that a proportional signal in relation to said flows is sent to a controller from each of said H₂ flow measuring device, said O₂ flow measuring device and said air flow measuring device. H₂ flowing to the combustion chamber is to have at least one flow control valve. O₂ flowing to the combustion chamber is to have at least one flow control valve. Air flowing to the combustion chamber is to have at least one flow control device in the form of a valve and/or a compressor. Each flow measuring device is to create a flow signal A controller is to have as input said H₂ flow signal, said O₂ flow signal and said air flow signal. Said controller is to receive an input signal from an external source indicating the combustion setpoint. Said controller is to compare said combustion setpoint to said H₂ flow signal and/or to said engine rpm, sending a proportional signal to said H₂ flow control valve that is in proportion to the difference in said combustion setpoint and the said flow signal, thereby proportioning said H₂ flow control valve. The controller is to compare said O₂ flow signal and said air flow signal to an H₂ ratio setpoint, providing a proportional signal to said O₂ flow control valve and to said air flow control device, wherein said H₂ flow, said O₂ flow and said air flow are such that the molar ratio of H₂ to O₂ is approximately 2:1. In the case wherein said O₂ flow control valve signal is not near approximately 100%, said controller is to send a signal to close said air flow control device. In the case wherein said O₂ flow control valve signal is near approximately 100%, said controller is to compare said O₂ flow signal and said air flow signal to said H₂ ratio setpoint obtaining an air flow difference, thereby sending a proportional signal to said air flow control device that is in proportion to said difference, thereby proportioning said air flow control device.

To conserve energy, it is preferred that said H₂ flow control valve(s) consist of a two staged system of flow control valves. The first H₂ flow control valve is to control recycled H₂ to the combustion chamber, The first H₂ control valve is preferably to be downstream of generated H₂ and downstream of H₂ storage to control H₂ flow to the combustion chamber. The second H₂ flow control valve is to feed stored H₂ to the combustion chamber. The second H₂ flow control valve is preferably to remain closed until the first H₂ flow control valve is near approximately 100% open (thereby assuring about full usage of generated H₂ prior usage of stored H₂) at which time the second H₂ flow control valve will begin proportioned by the controller according to the H₂ setpoint flow control signal. It is also preferred that a recycle H₂ control valve be placed to control the recycle of H₂ to H₂ storage. Said recycle H₂ control valve is to be proportional to the first H₂ control valve position near 100% closed. It is preferred that said controller proportion said recycle H₂ control valve in relation to the first H₂ control valve near a 0 position or 100% closed.

To conserve energy, it is preferred that said O₂ flow control valve(s) consist of a two staged system of flow control valves. The first O₂ flow control valve, downstream of generated O₂ and downstream of H₂ storage is preferably to control H₂ flow to the combustion chamber. The second H₂ flow control valve is to feed stored O₂ to the combustion chamber. The second H₂ flow control valve is to remain closed until the first O₂ flow control valve is near approximately 100% open (thereby assuring full usage of generated O₂ prior usage of stored O₂) at which time the second O₂ flow control valve will begin proportioned by the controller according to the H₂ setpoint flow control signal. It is also preferred that a recycle O₂ control valve be placed to control the recycle of O₂ to O₂ storage. Said recycle O₂ control valve is to be proportional to the first O₂ control valve position near 100% closed. It is preferred that said controller proportion said recycle O₂ control valve in relation to the first O₂ control valve near a position or 100% closed.

It is preferred that said combustion comprises an available H₂O flow to said combustion chamber(s), herein termed as combustion H₂O. It is preferred that a source of coolant flow to and/or through the block of the combustion chamber. It is preferred that a temperature measurement device have a means of measuring combustion temperature or approximating combustion temperature. It is preferred that there is a means to measure said combustion H₂O flow. It is preferred that there is a means to measure said coolant flow. It is preferred that there is a means to indicate engine rpm. It is preferred to send a signal to a controller from each of said combustion H₂O flow measuring device, said coolant flow measuring device and said combustion temperature measuring device. Said controller is to have as input previous said H₂ flow signal, said engine rpm, said combustion H₂O flow signal, said coolant flow signal and said temperature signal. It is preferred that said controller have a hot temperature setpoint, a coolant temperature setpoint, a warm temperature setpoint, an engine rpm setpoint and an H₂/H₂O ratio setpoint. It is preferred that said controller compare said H₂ flow signal and said combustion H₂O flow signal to said H₂/H₂O ratio setpoint in combination with comparing said engine rpm signal to said engine rpm setpoint, temperature signal to said warm temperature setpoint, said coolant temperature setpoint, said hot temperature setpoint and provide a proportional signal to said combustion H₂O flow control vale and to said coolant flow control valve.

In the case wherein said temperature signal is less than said warm temperature setpoint, less than said coolant temperature setpoint and less than said hot temperature setpoint, it is preferred that said controller send a signal to said coolant flow control valve to close said coolant flow control valve; and send a signal to said combustion H₂O flow control valve to close said combustion H₂O flow control valve.

In the case wherein said H₂/H₂O ratio is about greater than said H₂/H₂O ratio setpoint and said temperature signal is about equal to or greater than said warm temperature setpoint, less than said coolant temperature setpoint, less than said hot temperature setpoint and engine rpm signal is greater than said engine rpm setpoint, it is preferred that said controller send a signal to said coolant flow control valve to dose said coolant flow control valve and send a signal to said combustion H₂O flow control valve, wherein said signal is proportional to the difference between said measured temperature signal and the warm temperature setpoint, thereby proportioning said combustion H₂O flow control valve.

In the case wherein said H₂/H₂O ratio is about greater than said H₂/H₂O ratio setpoint and said temperature signal greater than said warm temperature setpoint, equal to or greater than said coolant setpoint, less than said hot temperature setpoint and engine rpm signal is greater than said engine rpm setpoint, it is preferred that said controller send a signal to the combustion H₂O flow control valve, thereby proportioning said combustion H₂O flow control valve; and send a signal to said coolant flow control valve, wherein said signal is proportional to the difference between said temperature signal and said coolant setpoint, thereby proportioning said coolant flow control valve.

In the case wherein said H₂/H₂O ratio is about greater than said H₂/H₂O ratio setpoint and said temperature signal is greater than said warm temperature setpoint, greater than said coolant setpoint and equal to or greater than said hot temperature setpoint, it is preferred that said controller send a signal to: close the combustion H₂O flow control valve; send a signal in proportion to the difference between the temperature signal and said coolant setpoint to said coolant flow valve, thereby proportioning said coolant flow control valve; and send a signal to said H₂ flow control valve, thereby dosing said H₂ flow control valve; and send a signal to said O₂ flow control valve, thereby closing said O₂ flow control valve: and send a signal to said air flow control device thereby dosing said air flow control device.

It is most preferred that the engine operate at a temperature between said warm temperature setpoint and said coolant temperature setpoint. It is preferred that energy not leave the engine via engine coolant. It is most preferred that required engine cooling be performed by the addition of combustion H₂O to the combustion chamber(s).

It is preferred that said engine and apparatus obtain O₂ from at least one of: O₂ storage, a cryogenic distillation unit, a membrane separation unit, an air SA separation unit, an electrolysis unit converting H₂O into H₂ and O₂ and/or any combination therein. Said cryogenic distillation unit is to obtain O₂ from at least one of air and/or said electrolysis unit. It is preferred that said cryogenic distillation unit separate H₂ from air. It is preferred that the cryogenic N₂ from said cryogenic distillation unit be used to cool any portion of at least one selected from a list consisting of: said cryogenic air separation unit, the storage of O₂, the storage of H₂, electrolysis, coolant for said engine, said engine and any combination thereof. Said membrane air separation unit and/or said air SA separation unit is preferably to obtain O₂ from air. Said cryogenic distillation unit, said air membrane separation unit and said air SA separation unit is to preferably be powered by said engine. It is preferred that at least one of said H₂ and said O₂ be at least partially used in said engine. It is preferred that at least one of said H₂ and said O₂ be stored at a cryogenic temperature. It is preferred that at least one of said H₂ and said O₂ be liquefied by a liquefaction unit, as known in the art.

Materials of construction for the engine are to be those as known in the art for each application as said application is otherwise performed in the subject art. For example, various composite and metal alloys are known and used as materials for use at cryogenic temperatures. Various composite, ceramic and metal alloys are known and used as materials for use at operating temperatures of over 500° F. Various ceramic materials can be conductive, perform at operating temperatures of over 2,000° F., act as an insulator, act as a semiconductor and/or perform other functions. Various iron compositions and alloys are known for their performance in combustion engines that operate approximately in the 200 to 1,500° F. range. Titanium and titanium alloys are known to operate over 2,000 and 3,000° F. Tantalum and tungsten are known to operate well over 3,000° F. It is preferred to have at least a portion of the construction of the engine contain an alloy composition wherein at least one of a period 4, period 5 and/or a period 6 heavy metal is used, as that metal(s) is known in the art to perform individually or to combine in an alloy to limit corrosion and/or perform in a cryogenic temperature application and/or perform in a temperature application over 1,000° F. While aluminum is lightweight and can perform in limited structural applications, aluminum is temperature limited. Due to the operating temperatures involved in the WCT Engine, thermoplastic materials are not preferred unless the application of use takes into account the glass transition temperature and the softening temperature of the thermoplastic material.

Application of the WCT—While there are many applications of the instant invention, a most preferred embodiment is that the instant invention comprises at least one of an internal combustion engine and a turbine. It is most preferred that the instant invention to power transportation devices. Transportation devices include yet are not limited to: automobiles, trucks, trains, airplanes and boats. A most preferred embodiment is to utilize the instant invention to generate electricity. A most preferred embodiment is to utilize the instant invention to generate steam.

Example 1 presents the Otto Cycle modified for the WCT engine in an internal combustion application. Examples 2 through 9 present results obtained via a computer model of the WCT engine developed according the presentation and results within Example 1. Said computer model was prepared with an Excel spreadsheet program, incorporating graphing capabilities. Said computer model was prepared incorporating the thermodynamic properties of H₂, O₂ and H₂O, along with the thermodynamic relationships presented in Example 1.

### Example 1

An Excel Spreadsheet Computer Model has been prepared for the instant invention. Said Model is the product of this example in the instant invention, the results of which are presented in Examples 2 through 9.

Operation of the instant invention is approximated by the cycling of a 4 stroke internal combustion engine as depicted in FIG. 9, wherein path a to b presents an intake stroke during which a H₂O vapor-fuel-oxidizer mixture is drawn into the combustion chamber as the piston moves outward. Next, the intake valve closes, wherein the piston moves inward thereby compressing the H₂O vapor, fuel and oxidizer mixture; this is depicted to be along the path from point “0” to point “1”. This is process is about adiabatic since it occurs rapidly.

At approximately near the end of the compression stroke, the mixture is ignited and the pressure increases rapidly along the path from point 1 to point 2. This process happens very quickly, thereby being nearly a pure isochoric (constant volume) process.

The power stroke is next, wherein the power stroke is about an adiabatic expansion from point 2 to point 3. At the end of the power stroke, the exhaust valve is opened, wherein the exhaust gases escape in an approximately isochoric process moving along the path from point 3 to point 4.

Finally, the piston again moves inward, thereby forcing exhaust gases out of the combustion chamber along the path b to a. And the cycle repeats . . . .

As net work is the product of pressure and volume, the net work performed is approximated by the area enclosed by the four path points: 0 to 1, 1 to 2, 2 to 3, and 3 to 4. The work done during the intake and exhaust strokes (the areas under paths a to b and b to a) cancel each other.

In this example, the instant invention comprises:

| | | |
|---|---|---|
| Number of cylinders | 6 | |
| Bore | 100.0 | mm |
| Stroke | 78.9 | mm |
| Compression ratio | 10 | |

### Compression—

$$\begin{matrix}Engine displacement = π \cdot {( \frac{bore}{2} )}^{2} \cdot ( stroke ) \cdot ( \# of cyls . ) \\ \begin{matrix}Displacement per cylinder = π \cdot {( 50 mm )}^{2} \cdot ( 78.9 mm ) \\ = 620 {cm}^{3} ( 0.62 l )\end{matrix} & \\ Compression ratio = c . r . = \frac{displacement + dead space}{dead space} & \end{matrix}$$

The dead space (volume remaining when the piston is fully inserted can be calculated from:

$$c . r . = 10.0 = \frac{620 + d . s .}{d . s .} -> 69 {mm}^{3} ( 0.069 l )$$

For simplicity we'll approximate 0.070 L for the dead space.

In this example, it is assumed that the intake mixture consists of H₂O vapor, oxidizer (O₂) and fuel (H₂). It is an embodiment that the intake mixture comprises H₂O vapor, wherein the oxidizer could be injected at any point during at least one of the compression stroke and the power stroke. Similarly, it is also an embodiment that the fuel could be injected at any point during at least one of the compression stroke and the power stroke. In this example it is assumed and is a preferred embodiment that the pressure at the beginning of the compression stroke is about 1 atmosphere. It is a most preferred embodiment that the pressure at the beginning of the compression stroke is greater than about 1 atmosphere. It is an embodiment that the pressure at the beginning of the compression stroke is about less than 1 atmosphere.

Again, in this example the embodiment comprising an intake mixture consists of H₂O vapor, O₂ and H₂ at 1 atmosphere pressure is depicted. In this depiction we can approximate the number of moles of H₂O vapor, fuel and O₂ in the cylinder at the beginning of the compression stroke from the ideal gas law.

$$n = \frac{P \cdot V}{R \cdot T}$$

$$n = \frac{( 1.0 atm ) \cdot ( 0.69 l )}{( 0.0821 l - atm / mole - K ) \cdot ( 300 K )} = 0.0280 moles$$

And, the pressure in the cylinder at the end of the compression stroke can be approximate by:

$$P \cdot {V}^{γ} = constant = {P}_{0} \cdot {V}_{0}^{γ}$$

$$P = {P}_{0} \cdot {( \frac{{V}_{0}}{V} )}^{γ}$$

$$P = ( 1.0 atm ) \cdot {( \frac{0.690 l}{0.070 l} )}^{1.4} = 24.6 atm$$

The temperature in the combustion chamber at the end of compression can be approximated by:

$$T = \frac{P \cdot V}{n \cdot R}$$

$$T = \frac{( 24.6 atm ) \cdot ( 0.070 l )}{( 0.0280 moles ) \cdot ( 0.0821 l - atm / mole \cdot K )}$$

$$T = 749.1 K$$

with the resulting curve in FIG. 9.
Combustion—The chemical reaction between H₂ and O₂ can be approximated by:

2H₂+O₂→2H₂O+137 kcal

In this example, it is assumed that near 0.0280 moles of H₂, O₂ and H₂O are in the cylinder (for this example, knowing that there may be more or less); it is further assumed that the gas mixture comprises about 18% O₂, 36% H₂ and 46% H₂O vapor (for this example, knowing that there may be more or less of each, except it is most preferred that the H₂ be about near twice the concentration of the O₂). It is an embodiment that these percentages may be varied as needed; however, it is most preferred that the molar concentration of H₂ be about near twice the molar concentration of the O₂. Therefore, in this example the combustion chamber comprises about 0.0050 moles of O₂ along with 0.0100 moles of H₂; and, assuming near complete combustion, said near 0.0050 moles of O₂ and said near 0.0100 moles of H₂ should yield about 2.87 kJ of energy. And, since about no work is done during combustion, the first law of thermodynamics requires that said 2.87 kJ be retained as internal energy of the reaction products which will raise their temperatures in proportion to the number of moles present and the specific heat of the gas. For H₂O is about 0.0280 moles with a heat capacity of about 36.2 J/mole-K. The temperature rise is then approximated by:

ΔT=Q/(n_{H}_{₂}_{O}·C_{H}_{₂}_{O})

ΔT=2.87 kJ/(0.0280·36.2)=2831 K

Since the temperature at the start of the combustion was estimated near 749.1 K, the final temperature following combustion is about 749.1 K+2831 K or 3580 K Having an approximation of the temperature rise, the final pressure is approximated from the ideal gas law and the total number of moles of gases present:

$$\begin{matrix}Pressure = \frac{( 0.0280 moles ) \cdot ( 0.0821 l - atm / mole - K ) \cdot ( 3580 K )}{0.070 l} \\ = 117.6 atm ( 1728 psi )\end{matrix}$$

The increase in pressure from 24.6 atm to 117.6 atm is near constant volume and is depicted as the vertical line from point 1 to point 2 on the P-V diagram of FIG. 9.
Expansion—Having approximated the pressure at the beginning of the expansion stroke (and knowing the volume) it is possible to approximate the pressure as a function of volume during the expansion:

$$P = {P}_{0} \cdot {( \frac{{V}_{0}}{V} )}^{γ}$$

$$P = ( 117.6 atm ) \cdot {( \frac{0.070 l}{V} )}^{1.4}$$

This line is depicted as the line from point 2 to point 3 on the P-V diagram, FIG. 9.
Exhaust—The exhaust stroke is depicted from point 3 to point 0 on the P-V diagram of FIG. 9.
Work Performed—Work is only done by (or on) the system during the adiabatic processes which can be approximated as follows:

$$W = \int P \cdot d V$$

$$P \cdot {V}^{γ} = {P}_{0} \cdot {V}_{0}$$

$$W = \int {{P}_{0} ( \frac{{V}_{0}}{V} )}^{γ} \cdot d V , where$$

$$W = \frac{{P}_{0} \cdot V}{1 - γ} {( \frac{{V}_{0}}{V} )}^{γ} {\vert}_{{V}_{i}}^{{V}_{\int }}$$

| Parameter | Compression | Expansion | Units |
|---|---|---|---|
| P₀ | 1.0 | 117.6 | atm |
| V₀ (Vᵢ) | 0.690 | 0.070 | liters |
| Vf | 0.070 | 0.690 | liters |
| Work | −2.42 | 12.35 | l-atm |

Therefore, the net work performed during each cycle is 12.35-2.42 L-atm, 9.93 L-atm (1.006 kJ).
Total horsepower—For a typical automobile running at 60 MPH the engine speed is approximately 3000 rpm is near 50 revolutions per second (this approximation can be modified for alternate rpm situations given alternate transmission situations). Since in a 4 stroke engine a cylinder has a power stroke only every other revolution, it will be firing at a rate of 25 power strokes per second. A six-cylinder engine will then have 150 power strokes per second. Thus, the total power will be near

(150 power strokes/sec)·(1.006 kJ/stroke)/0.746 kW/hp=202 hp

And, in a 2 stroke engine near twice the power is produced per second; therefore, a reduction of near 50% would be required in the combination of at least one of fuel and oxidizer, rpm, the number of cylinders or some combination therein. However, there are a whole host of effects that take this energy away such as less-than-ideal volumetric efficiency, friction, inefficient combustion, extraneous heat losses, and accelerating inertial masses. This can easily take up 75 to 85% of the power leaving only about 30 to 50 hp delivered to the rear wheels (at 60 MPH).
Torque and power—In a gasoline-powered internal combustion engine torque and power are derived from a combustion process which relies on a mixture of air and fuel. The air consists of a fixed percentage of oxidizer (O₂) near 18-21%. The remaining components of the air provide no oxidizer to combustion. The amount of fuel that can be combusted is determined by the amount of oxidizer present. The maximum amount of fuel and oxidizer that can be admitted to the cylinder is always limited by having a large, fixed amount of N₂ and other inert gases that comprise near 79-82% of the air.

The amount of torque and power is determined by the amount of air-fuel mixture admitted to the cylinder during the intake stroke of the engine. At low engine speeds the flow of air and fuel is reduced by means of a restriction placed in the path of the incoming mixture. This is typically accomplished by a device called a throttle plate. At lowest engine speed the throttle restriction is a maximum. As the throttle restriction is removed additional power and torque are developed and engine speed increases. Therefore there is a direct link between engine speed and the amount of torque and power output of the engine.

It is an embodiment of this instant invention that the amount of oxidizer (O₂) and fuel (H₂) admitted to the combustion chamber can be varied independently of the speed of the engine. Further, the amount of oxidizer is not limited by a fixed percentage of inert gases. Therefore, in the instant invention there is a preferred embodiment to change at least one of torque and power independent of engine speed. It is a preferred embodiment that the instant invention comprise the capability of a near vertical torque curve at a given rpm, wherein said torque curve is depicted as a function of engine rpm. This vertical torque capability, curve, as a function of engine rpm is termed herein the “WCT Torque Curve”.

The WCT Torque Curve provides embodiments within the instant invention which are not available for a hydrocarbon fueled internal combustion engine, wherein atmospheric air is used as the oxidizer for combustion. The embodiment of the WCT Torque Curve is ability to increase and/or decrease torque independent of rpm and to increase torque at low engine speeds. This ability to increase and/or decrease torque independent of engine rpm provides an engine which can provide greater torque and/or acceleration at lower rpm than a hydrocarbon/atmospheric air engine of comparable size. The WCT Torque Curve therein also provides greater flexibility in matching engine output to work needs, which thereby minimizes the need for transmission, as is required for a hydrocarbon/atmospheric air engine. Taken together, these embodiments provide for an engine and transmission which is at least one of smaller and lighter, while achieving performance which is at least comparable to that provided by a conventional hydrocarbon/atmospheric air engine.

### Example 2

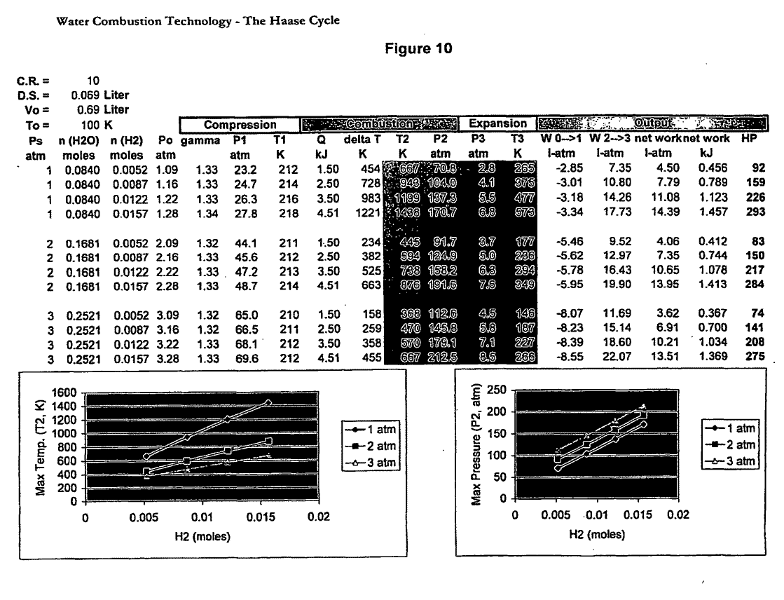

Utilizing a computer model developed from the information developed in Example 1, and written into an Excel spreadsheet program, FIG. 10 presents results wherein T₀=100 K, and within each stroke the moles of H₂ range from 0.005 to 0.016 along with the moles of O₂ in a stoichiometric relationship to those of H₂, and the moles of H₂O vary from 0.084 to 0.252.

### Example 3

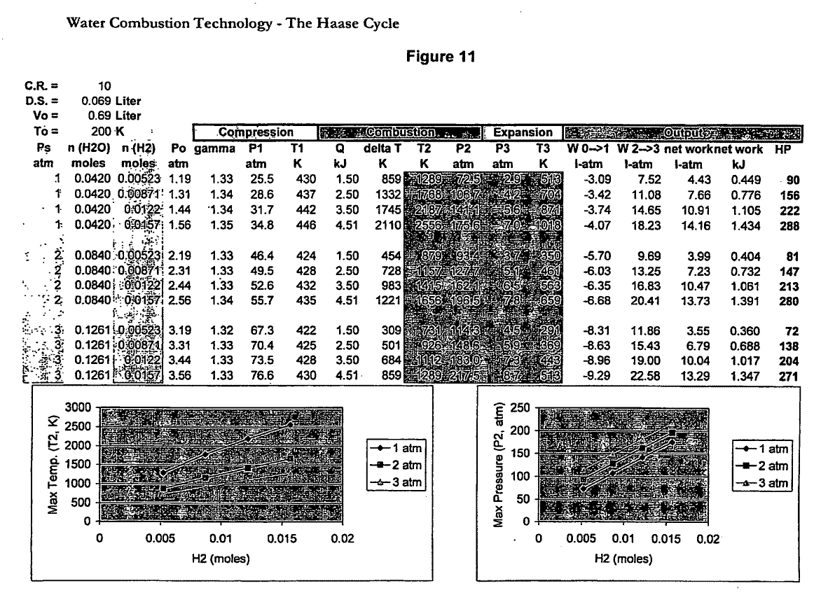

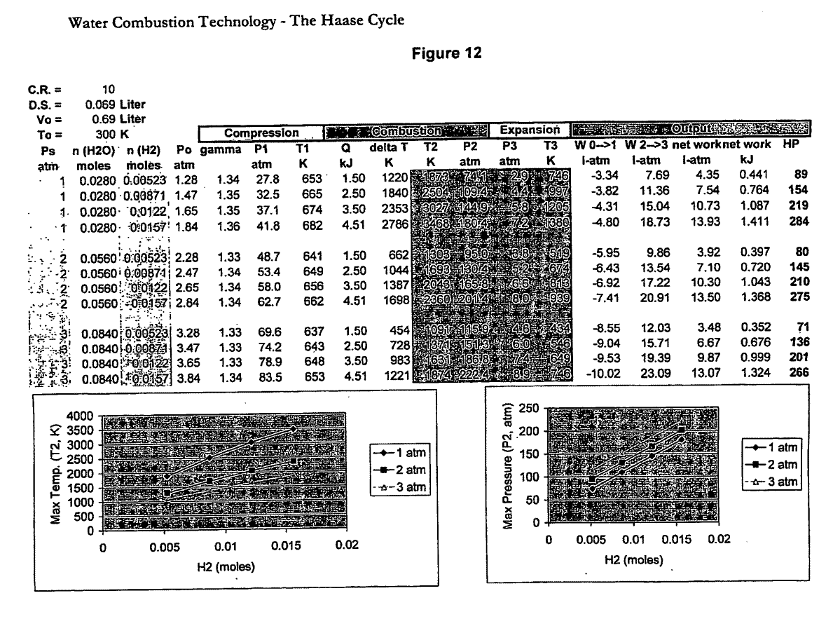

Utilizing the computer model developed in Example 1, and written into an Excel spreadsheet program, FIG. 11 presents results wherein T₀=200 K, and within each stroke the moles of H₂ range from 0.005 to 0.016 along with the moles of O₂ in a stoichiometric relationship to those of H₂, and the moles of H₂O vary from 0.042 to 0.126.

### Example 4

Utilizing the computer model developed in Example 1, and written into an Excel spreadsheet program, FIG. 12 presents results wherein T₀=300 K, and within each stroke the moles of H₂ range from 0.005 to 0.016 along with the moles of O₂ in a stoichiometric relationship to those of H₂, and the moles of H₂O vary from 0.028 to 0.084.

### Example 5

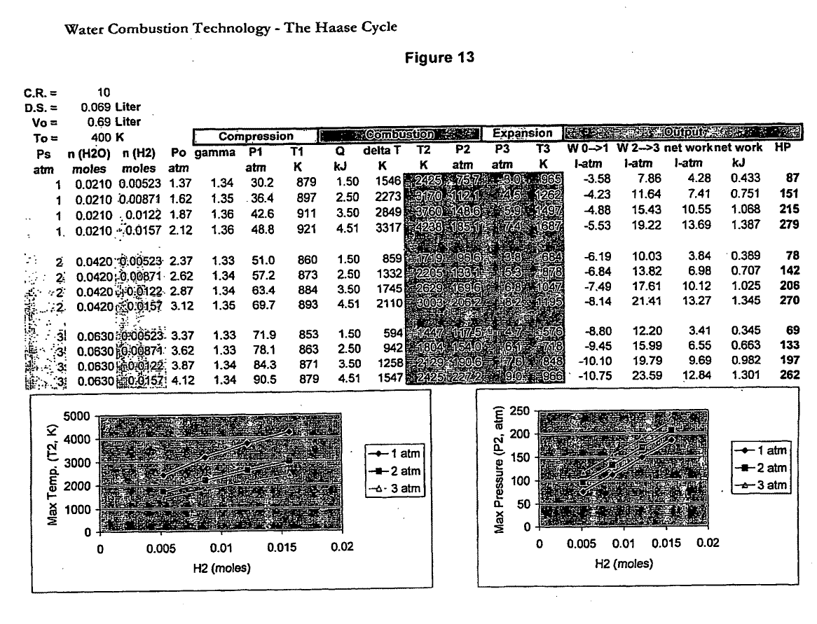

Utilizing the computer model developed in Example 1, and written into an Excel spreadsheet program, FIG. 13 presents results wherein T₀=400 K, and within each stroke the moles of H₂ range from 0.005 to 0.016 along with the moles of O₂ in a stoichiometric relationship to those of H₂, and the moles of H₂O vary from 0.021 to 0.063.

### Example 6

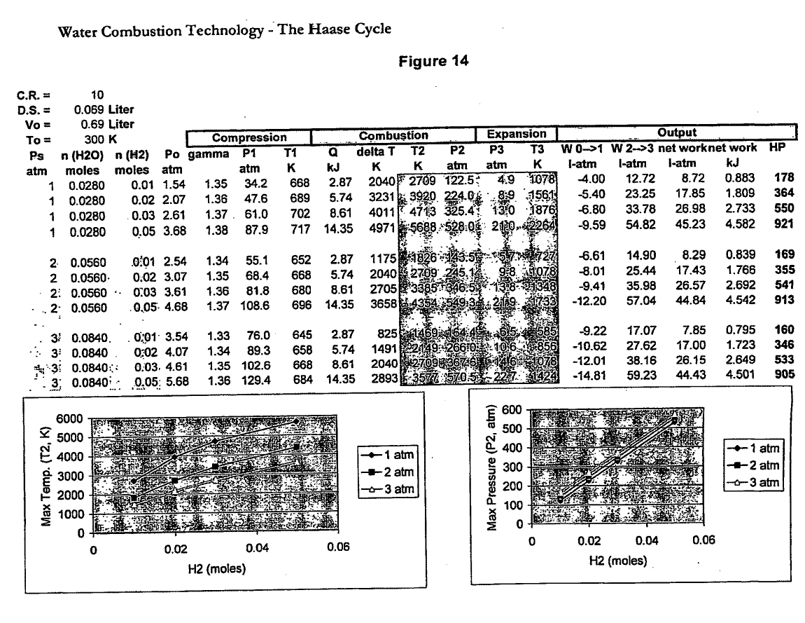

Utilizing the computer model developed in Example 1, and written into an Excel spreadsheet program, FIG. 14 presents results wherein T₀=300 K, and within each stroke the moles of H₂ range from 0.010 to 0.050 along with the moles of O₂ in a stoichiometric relationship to those of H₂, and the moles of H₂O vary from 0.028 to 0.084.

### Example 7

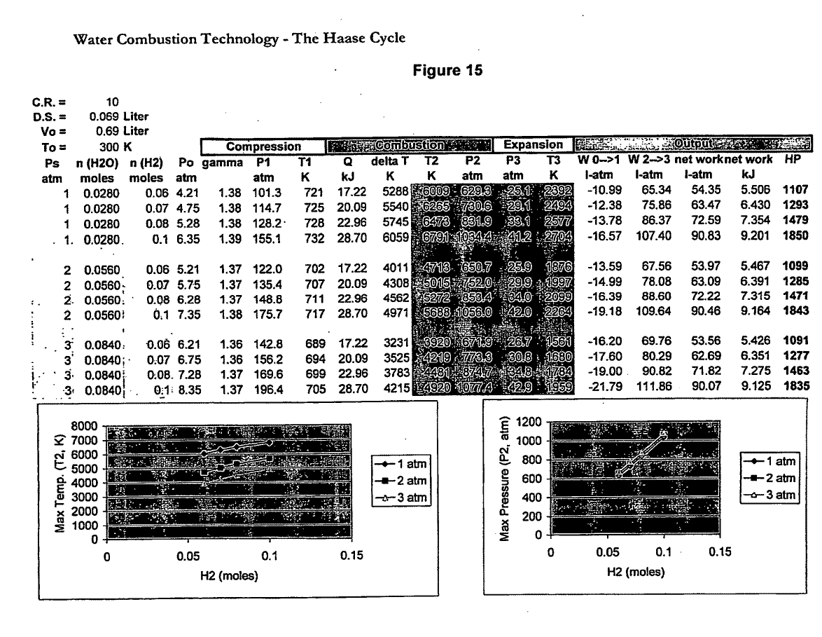

Utilizing the computer model developed in Example 1, and written into an Excel spreadsheet program, FIG. 15 presents results wherein T₀=300 K, and within each stroke the moles of H₂ range from 0.060 to 0.100 along with the moles of O₂ in a stoichiometric relationship to those of H₂, and the moles of H₂O vary from 0.028 to 0.084.

### Example 8

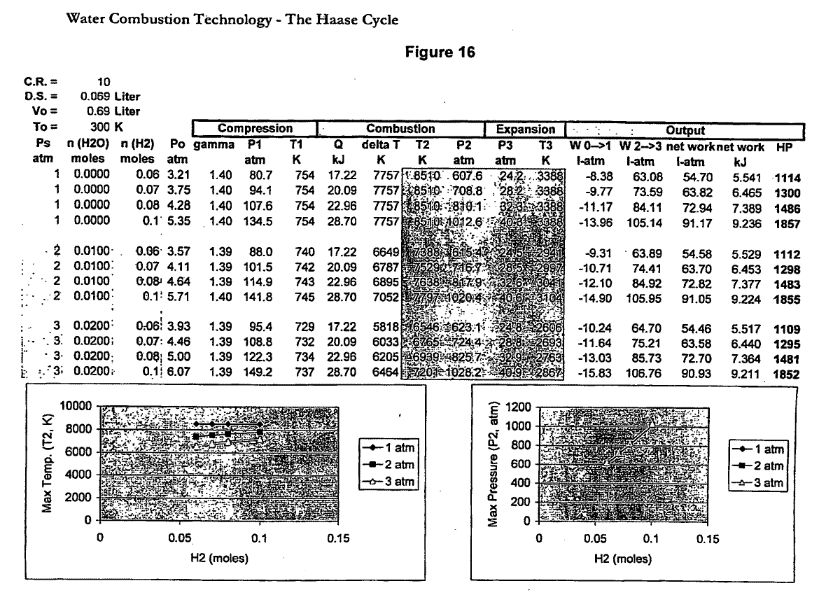

Utilizing the computer model developed in Example 1, and written into an Excel spreadsheet program, FIG. 16 presents results wherein T₀=300 K, and within each stroke the moles of H₂ range from 0.060 to 0.100 along with the moles of O₂ in a stoichiometric relationship to those of H₂, and the moles of H₂O vary from 0.000 to 0.020.

### Example 9

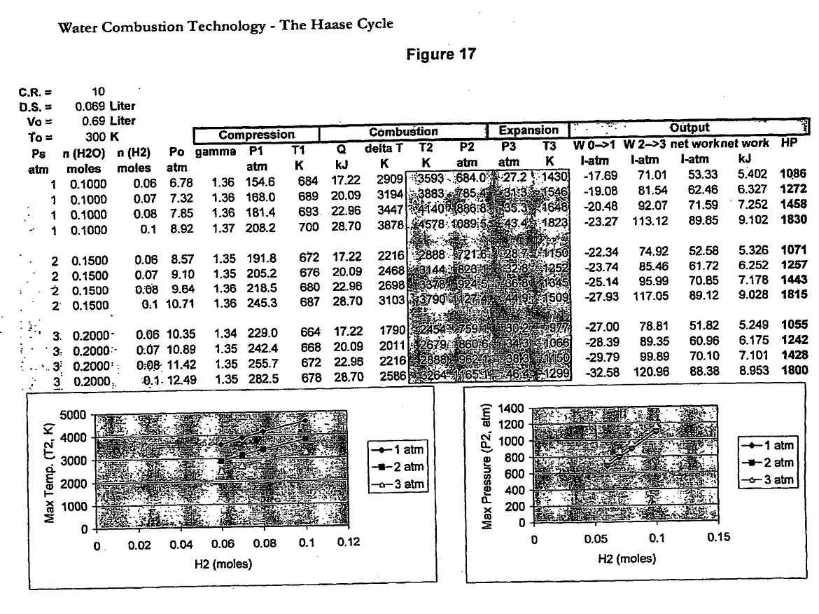

Utilizing the computer model developed in Example 1, and written into an Excel spreadsheet program, FIG. 17 presents results wherein T₀=300 K, and within each stroke the moles of H₂ range from 0.060 to 0.100 along with the moles of O₂ in a stoichiometric relationship to those of H₂, and the moles of H₂O vary from 0.100 to 0.200.

An additional computer model is developed for Examples 10 through 23 wherein the adiabatic expansion of steam is estimated using the adiabatic relationship:

$$W = \int P \cdot d V$$

$$P \cdot {V}^{γ} = {P}_{0} \cdot {V}_{0}$$

$$W = \int {{P}_{0} ( \frac{{V}_{0}}{V} )}^{γ} \cdot d V$$

$$W = \frac{{P}_{0} \cdot V}{1 - γ} {( \frac{{V}_{0}}{V} )}^{γ} {\vert}_{{V}_{I}}^{{V}_{\int }}$$

And the final temperature is estimated using the ideal gas law:

PV=nRT, wherein R=0.0821(L·atm)/(mole·K)

In each of examples 10 through 23 a molar amount of H₂O, as indicated, is heated to the indicated initial temperature from the heat of the combustion chamber to form steam, wherein said heat of the combustion chamber is enthalpy from the combustion of H₂ and O₂, wherein the indicated initial temperature and the indicted initial pressure is prior to adiabatic expansion, and wherein: the work performed, the final pressure and the final temperature are after adiabatic expansion of the steam. In the instant invention it is an embodiment to add H₂O to the combustion chamber after the combustion of H₂ and O₂ to cool the combustion chamber, wherein said H₂O is in the form of a liquid and/or a low pressure gas at a molar ratio of about 1:0.1 to about 1:12 of H₂:H₂O; it is most preferred that said molar ratio be about 1:6 to about 1:10; and, it is most preferred that said molar ratio be 1:8.

### Example 10

| | | Moles of H₂O | | | | | | | |
|---|---|---|---|---|---|---|---|---|---|
| | | 0.08 | 0.07 | 0.06 | 0.05 | 0.04 | 0.03 | 0.02 | 0.01 |
| Initial Temp | K | 500 | 500 | 500 | 500 | 500 | 500 | 500 | 500 |
| Initial volume | L | 0.07 | 0.07 | 0.07 | 0.07 | 0.07 | 0.07 | 0.07 | 0.07 |
| Final volume | L | 0.7 | 0.7 | 0.7 | 0.7 | 0.7 | 0.7 | 0.7 | 0.7 |
| Initial pressure | atm | 46.9 | 41.1 | 35.2 | 29.3 | 23.5 | 17.6 | 11.7 | 5.9 |
| Work | L-atm | 4.9 | 4.3 | 3.7 | 3.1 | 2.5 | 1.9 | 1.2 | 0.6 |
| Heat | cal | 860.4 | 752.9 | 645.3 | 537.8 | 430.2 | 322.7 | 215.1 | 107.6 |
| | L-atm | 35.4 | 31.0 | 26.6 | 22.1 | 17.7 | 13.3 | 8.9 | 4.4 |
| Delta T | K | 172.1 | 150.6 | 129.1 | 107.6 | 86.0 | 64.5 | 43.0 | 21.5 |
| Final pressure | atm | 18.68 | 16.34 | 14.01 | 11.67 | 9.34 | 7.00 | 4.67 | 2.33 |
| Final Temp | K | 199 | 199 | 199 | 199 | 199 | 199 | 199 | 199 |

### Example 11

| | | Moles of H₂O | | | | | | | |
|---|---|---|---|---|---|---|---|---|---|
| | | 0.08 | 0.07 | 0.06 | 0.05 | 0.04 | 0.03 | 0.02 | 0.01 |
| Initial Temp | K | 773 | 773 | 773 | 773 | 773 | 773 | 773 | 773 |
| Initial volume | L | 0.07 | 0.07 | 0.07 | 0.07 | 0.07 | 0.07 | 0.07 | 0.07 |
| Final volume | L | 0.7 | 0.7 | 0.7 | 0.7 | 0.7 | 0.7 | 0.7 | 0.7 |
| Initial pressure | atm | 72.5 | 63.5 | 54.4 | 45.3 | 36.3 | 27.2 | 18.1 | 9.1 |
| Work | l-atm | 7.6 | 6.7 | 5.7 | 4.8 | 3.8 | 2.9 | 1.9 | 1.0 |
| Heat | cal | 1057.0 | 924.8 | 792.7 | 660.6 | 528.5 | 396.4 | 264.2 | 132.1 |
| | l-atm | 43.5 | 38.1 | 32.6 | 27.2 | 21.7 | 16.3 | 10.9 | 5.4 |
| Delta T | K | 211.4 | 185.0 | 158.5 | 132.1 | 105.7 | 79.3 | 52.8 | 26.4 |
| Final pressure | atm | 28.87 | 25.27 | 21.66 | 18.05 | 14.44 | 10.83 | 7.22 | 3.61 |
| Final Temp | K | 308 | 308 | 308 | 308 | 308 | 308 | 308 | 308 |

### Example 12

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 500 | 500 | 500 | 500 | 500 | 500 | 500 | 500 |
| Initial volume | L | 0.07 | 0.14 | 0.21 | 0.28 | 0.35 | 0.42 | 0.49 | 0.56 |
| Final volume | L | 0.7 | 0.7 | 0.7 | 0.7 | 0.7 | 0.7 | 0.7 | 0.7 |
| Initial pressure | atm | 469.1 | 205.3 | 117.3 | 73.3 | 46.9 | 29.3 | 16.8 | 7.3 |
| Work | L-atm | 49.4 | 34.1 | 23.5 | 15.7 | 9.9 | 5.7 | 2.7 | 0.9 |
| Heat | cal | 8604.0 | 7528.5 | 6453.0 | 5377.5 | 4302.0 | 3226.5 | 2151.0 | 1075.5 |
| | L-atm | 354.1 | 309.8 | 265.6 | 221.3 | 177.0 | 132.8 | 88.5 | 44.3 |
| Delta T | K | 1720.8 | 1505.7 | 1290.6 | 1075.5 | 860.4 | 645.3 | 430.2 | 215.1 |
| Final pressure | atm | 18.68 | 21.56 | 21.74 | 20.32 | 17.78 | 14.34 | 10.17 | 5.36 |
| Final Temp | K | 199 | 263 | 309 | 347 | 379 | 408 | 434 | 457 |

### Example 13

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 773 | 773 | 773 | 773 | 773 | 773 | 773 | 773 |
| Initial volume | L | 0.07 | 0.14 | 0.21 | 0.28 | 0.35 | 0.42 | 0.49 | 0.56 |
| Final volume | L | 0.7 | 0.7 | 0.7 | 0.7 | 0.7 | 0.7 | 0.7 | 0.7 |
| Initial pressure | atm | 725.3 | 317.3 | 181.3 | 113.3 | 72.5 | 45.3 | 25.9 | 11.3 |
| Work | L-atm | 76.4 | 32.7 | 36.4 | 24.3 | 15.4 | 8.8 | 4.2 | 1.4 |
| Heat | Cal | 10569.6 | 9248.4 | 7927.2 | 6606.0 | 5284.8 | 3963.6 | 2642.4 | 1321.2 |
| | L-atm | 435.0 | 380.6 | 326.2 | 271.9 | 217.5 | 163.1 | 108.7 | 54.4 |
| Delta T | K | 2113.9 | 1849.7 | 1585.4 | 1321.2 | 1057.0 | 792.7 | 528.5 | 264.2 |
| Final pressure | atm | 28.87 | 33.34 | 33.61 | 31.42 | 27.48 | 22.17 | 15.72 | 8.29 |
| Final Temp | K | 308 | 406 | 478 | 536 | 586 | 630 | 670 | 707 |

### Example 14

| | | Moles of H₂O | | | | | | | |
|---|---|---|---|---|---|---|---|---|---|
| | | 0.08 | 0.08 | 0.06 | 0.05 | 0.04 | 0.03 | 0.02 | 0.01 |
| Initial Temp | K | 773 | 773 | 773 | 773 | 773 | 773 | 773 | 773 |
| Initial volume | L | 0.07 | 0.07 | 0.07 | 0.07 | 0.07 | 0.07 | 0.07 | 0.07 |
| Final volume | L | 0.9 | 0.9 | 0.9 | 0.9 | 0.9 | 0.9 | 0.9 | 0.9 |
| Initial pressure | atm | 72.5 | 72.5 | 54.4 | 45.3 | 36.3 | 27.2 | 18.1 | 9.1 |
| Work | L-atm | 8.1 | 8.1 | 6.1 | 5.1 | 4.1 | 3.0 | 2.0 | 1.0 |
| Heat | cal | 1057.0 | 1057.0 | 792.7 | 660.6 | 528.5 | 396.4 | 264.2 | 132.1 |
| | L-atm | 43.5 | 43.5 | 32.6 | 27.2 | 21.7 | 16.3 | 10.9 | 5.4 |
| Delta T | K | 211.4 | 211.4 | 158.5 | 132.1 | 105.7 | 79.3 | 52.8 | 26.4 |
| Final pressure | atm | 2.03 | 2.03 | 1.52 | 1.27 | 1.02 | 0.76 | 0.51 | 0.25 |
| Final Temp | K | 278 | 278 | 278 | 278 | 278 | 278 | 278 | 278 |

### Example 15

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 773 | 773 | 773 | 773 | 773 | 773 | 773 | 773 |
| Initial volume | L | 0.07 | 0.07 | 0.07 | 0.07 | 0.07 | 0.07 | 0.07 | 0.07 |
| Final volume | L | 0.9 | 0.9 | 0.9 | 0.9 | 0.9 | 0.9 | 0.9 | 0.9 |
| Initial pressure | atm | 725.3 | 634.6 | 544.0 | 453.3 | 362.6 | 272.0 | 181.3 | 90.7 |
| Work | L-atm | 81.2 | 71.1 | 60.9 | 50.8 | 40.6 | 30.5 | 20.3 | 10.2 |
| Heat | cal | 10569.6 | 9248.4 | 7927.2 | 6606.0 | 5284.8 | 3963.6 | 2642.4 | 1321.2 |
| | L-atm | 435.0 | 380.6 | 326.2 | 271.9 | 217.5 | 163.1 | 108.7 | 54.4 |
| Delta T | K | 2113.9 | 1849.7 | 1585.4 | 1321.2 | 1057.0 | 792.7 | 528.5 | 264.2 |
| Final pressure | atm | 20.31 | 17.77 | 15.23 | 12.69 | 10.16 | 7.62 | 5.08 | 2.54 |
| Final temp | K | 278 | 278 | 278 | 278 | 278 | 278 | 278 | 278 |

### Example 16

| | | Moles of H₂O | | | | | | | |
|---|---|---|---|---|---|---|---|---|---|
| | | 0.08 | 0.08 | 0.06 | 0.05 | 0.04 | 0.03 | 0.02 | 0.01 |
| Initial Temp | K | 773 | 773 | 773 | 773 | 773 | 773 | 773 | 773 |
| Initial volume | L | 0.35 | 0.35 | 0.35 | 0.35 | 0.35 | 0.35 | 0.35 | 0.35 |
| Final volume | L | 0.7 | 0.7 | 0.7 | 0.7 | 0.7 | 0.7 | 0.7 | 0.7 |
| Initial pressure | atm | 14.5 | 14.5 | 10.9 | 9.1 | 7.3 | 5.4 | 3.6 | 1.8 |
| Work | L-atm | 3.1 | 3.1 | 2.3 | 1.9 | 1.5 | 1.2 | 0.8 | 0.4 |
| Heat | cal | 1057.0 | 1057.0 | 792.7 | 660.6 | 528.5 | 396.4 | 264.2 | 132.1 |
| | L-atm | 43.5 | 43.5 | 32.6 | 27.2 | 21.7 | 16.3 | 10.9 | 5.4 |
| Delta T | K | 211.4 | 211.4 | 158.5 | 132.1 | 105.7 | 79.3 | 52.8 | 26.4 |
| Final pressure | atm | 5.50 | 5.50 | 4.12 | 3.44 | 2.75 | 2.06 | 1.37 | 0.69 |
| Final Temp | K | 586 | 586 | 586 | 586 | 586 | 586 | 586 | 586 |

### Example 17

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 773 | 773 | 773 | 773 | 773 | 773 | 773 | 773 |
| Initial volume | L | 0.35 | 0.35 | 0.35 | 0.35 | 0.35 | 0.35 | 0.35 | 0.35 |
| Final volume | L | 0.7 | 0.7 | 0.7 | 0.7 | 0.7 | 0.7 | 0.7 | 0.7 |
| Initial pressure | atm | 145.1 | 126.9 | 108.8 | 90.7 | 72.5 | 54.4 | 36.3 | 18.1 |
| Work | L-atm | 30.7 | 26.9 | 23.1 | 19.2 | 15.4 | 11.5 | 7.7 | 3.8 |
| Heat | cal | 10569.6 | 9248.4 | 7927.2 | 6606.0 | 5284.8 | 3963.6 | 2642.4 | 1321.2 |
| | L-atm | 435.0 | 380.6 | 326.2 | 271.9 | 217.5 | 163.1 | 108.7 | 54.4 |
| Delta T | K | 2113.9 | 1849.7 | 1585.4 | 1321.2 | 1057.0 | 792.7 | 528.5 | 264.2 |
| Final pressure | atm | 54.97 | 48.10 | 41.23 | 34.35 | 27.48 | 20.61 | 13.74 | 6.87 |
| Final Temp | K | 586 | 586 | 586 | 586 | 586 | 586 | 586 | 586 |

### Example 18

| | | Moles of H₂O | | | | | | | |
|---|---|---|---|---|---|---|---|---|---|
| | | 0.08 | 0.08 | 0.06 | 0.05 | 0.04 | 0.03 | 0.02 | 0.01 |
| Initial Temp | K | 1000 | 1000 | 1000 | 1000 | 1000 | 1000 | 1000 | 1000 |
| Initial volume | L | 0.07 | 0.07 | 0.07 | 0.07 | 0.07 | 0.07 | 0.07 | 0.07 |
| Final volume | L | 1.4 | 1.4 | 1.4 | 1.4 | 1.4 | 1.4 | 1.4 | 1.4 |
| Initial pressure | atm | 93.8 | 93.8 | 70.4 | 58.6 | 46.9 | 35.2 | 23.5 | 11.7 |
| Work | L-atm | 11.5 | 11.5 | 8.6 | 7.2 | 5.7 | 4.3 | 2.9 | 1.4 |
| Heat | cal | 1220.4 | 1220.4 | 915.3 | 762.8 | 610.2 | 457.7 | 305.1 | 152.6 |
| | L-atm | 50.2 | 50.2 | 37.7 | 31.4 | 25.1 | 18.8 | 12.6 | 6.3 |
| Delta T | K | 244.1 | 244.1 | 183.1 | 152.6 | 122.0 | 91.5 | 61.0 | 30.5 |
| Final pressure | atm | 1.42 | 1.42 | 1.06 | 0.88 | 0.71 | 0.53 | 0.35 | 0.18 |
| Final temp | K | 302 | 302 | 302 | 302 | 302 | 302 | 302 | 302 |

### Example 19

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 1000 | 1000 | 1000 | 1000 | 1000 | 1000 | 1000 | 1000 |
| Initial volume | L | 0.07 | 0.07 | 0.07 | 0.07 | 0.07 | 0.07 | 0.07 | 0.07 |
| Final volume | L | 1.7 | 1.7 | 1.7 | 1.7 | 1.7 | 1.7 | 1.7 | 1.7 |
| Initial pressure | atm | 938.3 | 821.0 | 703.7 | 586.4 | 469.1 | 351.9 | 234.6 | 117.3 |
| Work | L-atm | 118.4 | 103.6 | 88.8 | 74.0 | 59.2 | 44.4 | 29.6 | 14.8 |
| Heat | cal | 12204.0 | 10678.5 | 9153.0 | 7627.5 | 6102.0 | 4576.5 | 3051.0 | 1525.5 |
| | L-atm | 502.2 | 439.4 | 376.7 | 313.9 | 251.1 | 188.3 | 125.6 | 62.8 |
| Delta T | K | 2440.8 | 2135.7 | 1830.6 | 1525.5 | 1220.4 | 915.3 | 610.2 | 305.1 |
| Final pressure | atm | 10.79 | 9.44 | 8.09 | 6.74 | 5.39 | 4.04 | 2.70 | 1.35 |
| Final Temp | K | 279 | 279 | 279 | 279 | 279 | 279 | 279 | 279 |

### Example 20

| | | Moles of H₂O | | | | | | | |
|---|---|---|---|---|---|---|---|---|---|
| | | 0.08 | 0.08 | 0.06 | 0.05 | 0.04 | 0.03 | 0.02 | 0.01 |
| Initial Temp | K | 2000 | 2000 | 2000 | 2000 | 2000 | 2000 | 2000 | 2000 |
| Initial volume | L | 0.07 | 0.07 | 0.07 | 0.07 | 0.07 | 0.07 | 0.07 | 0.07 |
| Final volume | L | 9.8 | 9.8 | 9.8 | 9.8 | 9.8 | 9.8 | 9.8 | 9.8 |
| Initial pressure | atm | 187.7 | 187.7 | 140.7 | 117.3 | 93.8 | 70.4 | 46.9 | 23.5 |
| Work | L-atm | 28.3 | 28.3 | 21.2 | 17.7 | 14.1 | 10.6 | 7.1 | 3.5 |
| Heat | cal | 1940.4 | 1940.4 | 1455.3 | 1212.8 | 970.2 | 727.7 | 485.1 | 242.6 |
| | L-atm | 79.9 | 79.9 | 59.9 | 49.9 | 39.9 | 29.9 | 20.0 | 10.0 |
| Delta T | K | 388.1 | 388.1 | 291.1 | 242.6 | 194.0 | 145.5 | 97.0 | 48.5 |
| Final pressure | Atm | 0.19 | 0.19 | 0.14 | 0.12 | 0.09 | 0.07 | 0.05 | 0.02 |
| Final temp | K | 277 | 277 | 277 | 277 | 277 | 277 | 277 | 277 |

### Example 21

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 2000 | 2000 | 2000 | 2000 | 2000 | 2000 | 2000 | 2000 |
| Initial volume | L | 0.07 | 0.07 | 0.07 | 0.07 | 0.07 | 0.07 | 0.07 | 0.07 |
| Final volume | L | 9.8 | 9.8 | 9.8 | 9.8 | 9.8 | 9.8 | 9.8 | 9.8 |
| Initial pressure | atm | 1876.6 | 1642.0 | 1407.4 | 1172.9 | 938.3 | 703.7 | 469.1 | 234.6 |
| Work | L-atm | 282.9 | 247.5 | 212.2 | 176.8 | 141.5 | 106.1 | 70.7 | 35.4 |
| Heat | cal | 19404.0 | 16978.5 | 14553.0 | 12127.5 | 9702.0 | 7276.5 | 4851.0 | 2425.5 |
| | L-atm | 798.5 | 698.7 | 598.9 | 499.1 | 399.3 | 299.4 | 199.6 | 99.8 |
| Delta T | K | 3880.8 | 3395.7 | 2910.6 | 2425.5 | 1940.4 | 1455.3 | 970.2 | 485.1 |
| Final pressure | atm | 1.86 | 1.62 | 1.39 | 1.16 | 0.93 | 0.70 | 0.46 | 0.23 |
| Final temp | K | 277 | 277 | 277 | 277 | 277 | 277 | 277 | 277 |

### Example 22

| | | Moles of H₂O | | | | | | | |
|---|---|---|---|---|---|---|---|---|---|
| | | 0.08 | 0.08 | 0.06 | 0.05 | 0.04 | 0.03 | 0.02 | 0.01 |
| Initial Temp | K | 400 | 400 | 400 | 400 | 400 | 400 | 400 | 400 |
| Initial volume | L | 0.3 | 0.3 | 0.3 | 0.3 | 0.3 | 0.3 | 0.3 | 0.3 |
| Final volume | L | 0.7 | 0.7 | 0.7 | 0.7 | 0.7 | 0.7 | 0.7 | 0.7 |
| Initial pressure | atm | 8.8 | 8.8 | 6.6 | 5.5 | 4.4 | 3.3 | 2.2 | 1.1 |
| Work | L-atm | 1.9 | 1.9 | 1.4 | 1.2 | 0.9 | 0.7 | 0.5 | 0.2 |
| Heat | cal | 788.4 | 788.4 | 591.3 | 492.8 | 394.2 | 295.7 | 197.1 | 98.6 |
| | L-atm | 32.4 | 32.4 | 24.3 | 20.3 | 16.2 | 12.2 | 8.1 | 4.1 |
| Delta T | K | 157.7 | 157.7 | 118.3 | 98.6 | 78.8 | 59.1 | 39.4 | 19.7 |
| Final pressure | atm | 2.67 | 2.67 | 2.01 | 1.67 | 1.34 | 1.00 | 0.67 | 0.33 |
| Final temp | K | 285 | 285 | 285 | 285 | 285 | 285 | 285 | 285 |

### Example 23

| | | Moles of H₂O | | | | | | | |
|---|---|---|---|---|---|---|---|---|---|
| | | 0.8 | 0.7 | 0.6 | 0.5 | 0.4 | 0.3 | 0.2 | 0.1 |
| Initial Temp | K | 400 | 400 | 400 | 400 | 400 | 400 | 400 | 400 |
| Initial volume | L | 0.3 | 0.3 | 0.3 | 0.3 | 0.3 | 0.3 | 0.3 | 0.3 |
| Final volume | L | 0.7 | 0.7 | 0.7 | 0.7 | 0.7 | 0.7 | 0.7 | 0.7 |
| Initial pressure | atm | 87.6 | 76.6 | 65.7 | 54.7 | 43.8 | 32.8 | 21.9 | 10.9 |
| Work | L-atm | 18.9 | 16.5 | 14.2 | 11.8 | 9.4 | 7.1 | 4.7 | 2.4 |
| Heat | cal | 7884.0 | 6898.5 | 5913.0 | 4927.5 | 3942.0 | 2956.5 | 1971.0 | 985.5 |
| | L-atm | 324.4 | 283.9 | 243.3 | 202.8 | 162.2 | 121.7 | 81.1 | 40.6 |
| Delta T | K | 1576.8 | 1379.7 | 1182.6 | 985.5 | 788.4 | 591.3 | 394.2 | 197.1 |
| Final pressure | atm | 26.74 | 23.40 | 20.06 | 16.71 | 13.37 | 10.03 | 6.69 | 3.34 |
| Final temp | K | 285 | 285 | 285 | 285 | 285 | 285 | 285 | 285 |

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description, it is to be realized that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention, It is also to be understood that the following claims are intended to cover all of the generic and specific features of the invention herein described, and all statements of the scope of the invention, which, as a matter of language, might be said to fall in between.

1. An engine comprising a combustion chamber, wherein
H₂ is combusted with O₂ in the combustion chamber, and wherein the engine performs combustion with at least one selected from a list consisting of:
H₂O is added to the combustion chamber during exhaust of combustion gases from the combustion chamber;
said H₂ is at least partially added to the combustion chamber during combustion;
said O₂ is at least partially added to the combustion chamber during combustion;
H₂O is added to the combustion chamber during at least one cycle or operating time wherein combustion is not performed and the H₂O absorbs enthalpy from the combustion chamber, thereby creating steam energy cooling the combustion chamber; and
any combination therein.

2. The engine of claim 1, wherein said O₂ further comprises N₂ or Ar.

3. The engine of claim 1, wherein said O₂ further comprises air.

4. The engine of claim 1, wherein said engine comprises 2 cycles.

5. The engine of claim 1, wherein said engine comprises 4 or more cycles.

6. The engine of claim 1, wherein said H₂ is at least partially stored as a gel.

7. The engine of claim 1, wherein said O₂ is at least partially stored as a gel.

8. The engine of claim 1, further comprising a WCT Torque Curve.

9. The engine of claim 1, further comprising a Newsom burn.

10. The engine of claim 1, wherein at least one of said H₂ and said O₂ is added to said combustion chamber at a pressure of greater than about 1 atmosphere.

11. The engine of claim 1, wherein the use of said engine comprises transportation or power generation.

12. The engine of claim 1, wherein said O₂ is at least one of: enriched O₂, pure O₂ and very pure O₂.

13. The engine of claim 1, wherein electricity is generated by at least one selected from the group consisting of: photovoltaic cell(s), a generator, alternator or dynamo turned by moving air or moving H₂O, nuclear means, and any combination therein, wherein
said electricity is at least partially utilized in an electrolysis unit to convert H₂O to H₂ and O₂, and wherein
at least a portion of at least one of the H₂ and the O₂ is used in said combustion chamber.

14. The engine of claim 1, wherein said engine creates at least one selected from the group consisting of: rotating mechanical energy, torque, power, and any combination therein.

15. The engine of claim 14, wherein said rotating mechanical energy turns an alternator, generator or dynamo to create electricity.

16. The engine of claim 14, wherein said mechanical rotating energy enters a transmission, wherein
said transmission engages in a manner that is inversely proportional to at least one of the torque and work load on said engine, and wherein
said transmission output mechanical rotating energy turns an alternator or a generator to create electricity.

17. The engine of claim 16, wherein said transmission engage a flywheel capable of storing rotational kinetic energy, wherein
said flywheel turns said alternator or generator.

18. The engine of claim 1, wherein said engine produces steam.

19. The engine of claim 18, wherein at least a portion of said steam turns a steam turbine, and wherein
the steam turbine turns an alternator, generator or dynamo to create electricity.

20. The engine of claim 15, 16 or 19, wherein at least a portion of said electricity is used in an electrolysis unit, wherein
said electrolysis unit converts H₂O to H₂ and O₂, wherein
at least a portion of at least one of the H₂ and the O₂ is used in said combustion chamber.

21. The engine of claim 18, wherein at least a portion of said steam is converted in a unit to H₂ by the corrosion of at least one metal.

22. The engine of claim 21, wherein the conversion of said steam into said H₂ is increased by an electrical current in said metal(s).

23. The engine of claim 21 or 22, wherein said H₂ is at least partially used in said combustion chamber.

24. The engine of claim 1, further comprising a cryogenic air separation unit, wherein
said engine or the steam from said engine powers at least a portion of the cryogenic air separation unit.

25. The engine of claim 24, wherein the N₂ separated from air is used to cool any portion of at least one selected from the group consisting of: said cryogenic air separation unit, the storage of O₂, the storage of H₂, electrolysis, coolant for said engine, said engine, and any combination thereof.

26. The engine of claim 24, wherein the N₂ separated from air is at least partially used to cool air or H₂O.

27. The engine of claim 24, wherein the N₂ separated from air is at least partially used to turn a turbine, wherein
said turbine performs at least one of:
power a cryogenic refrigeration unit to chill or liquefy at least one of H₂ and O₂, and
turn a generator to create electricity.

28. The engine of claim 24, wherein H₂ is separated in said cryogenic distillation unit.

29. The engine of claim 1, incorporating a membrane air separation unit, wherein
said engine or the steam from said engine powers at least a portion of said membrane air separation unit.

30. The engine of claim 1, incorporating a SA air separation unit, wherein
said engine or the steam from said engine powers at least a portion of said SA air separation unit.

31. The engine of claim 24, 29 or 30, wherein the O₂ separated from air is at least one of enriched O₂, pure O₂ and very pure O₂.

32. The engine of claim 24, 29 or 30, wherein at least a portion the O₂ separated from air is used in said combustion chamber.

33. The engine of claim 1, wherein at least a portion of at least one of said combustion chamber and said engine is insulated.

34. The engine of claim 1, wherein at least one of O₂ and H₂ is stored in at least one of a cooled gas state and a liquid state by a liquefaction unit.

35. The engine of claim 34, wherein the compressor(s) for at least one of cooling and/or liquefaction is powered by at least one selected from a list consisting of said engine, steam from said engine, the expansion of cryogenic N₂ and an outside electrical source.

36. The engine of claim 1, wherein at least one of combustion heat energy and engine exhaust energy is used in a unit to heat at least one of a gas and a liquid.

37. The engine of claim 36, wherein at least one of the gas is air and the liquid is H₂O.

38. The engine of claim 1, wherein said engine is at least one of an internal combustion engine and a turbine.

39. The engine of claim 38, wherein said engine comprises Energy Recovery Cooling.

40. The engine of claim 1, wherein at least one of:
the material(s) of construction of said combustion chamber comprise a heat capacity capable of storing heat from the previous combustion as enthalpy for the transfer from said combustion chamber to said H₂O; and
the material(s) of construction of said combustion chamber comprise a heat transfer coefficient capable of transferring heat from the previous combustion within the material(s) of said combustion chamber to said H₂O.

41. The engine of claim 18, wherein at least a portion of at least one said steam and the H₂O exiting said engine is transferred to a condenser.

42. The engine of claim 41, wherein at least a portion of the H₂O from said condenser is used in said combustion chamber.

43. The engine of claim 41, wherein at least a portion of the H₂O from said condenser is used in an electrolysis unit, wherein
said electrolysis unit converts at least a portion of said H₂O into H₂ and O₂, and wherein
at least a portion of said H₂ or O₂ is used in said combustion chamber.

44. The engine of claim 19, wherein at least a portion of at least one of the steam and the H₂O exiting said turbine is transferred to a condenser.

45. The engine of claim 44, wherein at least a portion of the H₂O from said condenser is used in said combustion chamber.

46. The engine of claim 44, wherein at least a portion of the H₂O from said condenser is used in an electrolysis unit, wherein
the electrolysis unit converts at least a portion of the H₂O into H₂ and O₂, and wherein
at least a portion of the H₂ or the O₂ is used in said combustion chamber.

47. The engine of claim 43 or 46, wherein the electricity for said electrolysis unit is at least partially obtained from the turning of at least one of a generator, an alternator and a dynamo, and wherein
said at least one generator, alternator and dynamo is turned by the energy of at least one selected from the group consisting of: steam turbine turned by the exhaust gases (steam) from said combustion chamber(s), drive shaft turned by the energy created in said combustion chamber(s), moving wind energy, moving H₂O energy, and any combination therein.

48. The engine of claim 1, further comprising at least one pressure control device.

49. The engine of claim 1, wherein at least one selected from a list consisting of a: corrosion inhibitor, chelant, dispersant, electrolyte, and any combination therein is added to said H₂O.
